(19) United States
(12) Patent Application Publication
(10) Pub. No.: US 2023/0123504 A1
(43) Pub. Date: Apr. 20, 2023

(54) SYSTEMS AND METHODS FOR CONTROLLED CLEANING OF VEHICLES

(71) Applicant: Paolozzi Investments, Inc., Vienna, VA (US)

(72) Inventors: Guy Anthony Paolozzi, Vienna, VA (US); Nicholas Noah Bush, Chagrin Falls, OH (US); Benjamin R. Greenberg, San Antonio, TX (US); Jorge L. Nicho, San Antonio, TX (US); Jeremy K. Zoss, San Antonio, TX (US); Douglas C. Smith, San Antonio, TX (US); Matthew M. Robinson, San Antonio, TX (US); Reid Christopher, San Antonio, TX (US); Tyler Marr, San Antonio, TX (US)

(21) Appl. No.: 17/968,709

(22) Filed: Oct. 18, 2022

Related U.S. Application Data
(60) Provisional application No. 63/256,763, filed on Oct. 18, 2021.

(51) Int. Cl. B60S 3/00; B25J 9/16; B25J 11/00; B25J 9/00

(52) U.S. Cl. CPC B60S 3/008; B25J 9/1697; B25J 9/163; B25J 11/0085; B25J 9/1666; B25J 9/0093

(57) ABSTRACT

Systems and methods disclosed herein include a robotic arm positioned outside of the vehicle. The robotic arm may include an end effector configured as a cleaning implement for cleaning a surface in the interior of the vehicle. The system may include a first camera configured to determine a position of the vehicle with respect to a reference point. The system may include a second camera configured to scan the interior of the vehicle. The second system may include a first controller configured to create and/or modify a tool path to execute a cleaning operation, based on the scan, and to send instructions to the robotic arm to execute the cleaning operation in accordance with the created and/or modified tool path.

### PRIORITY

This application claims priority to U.S. Provisional Patent Application No. 63,256,763 filed on Oct. 18, 2021, the contents of which are incorporated herein by reference in its entirety.

### TECHNICAL FIELD

The present disclosure relates to systems and methods for controlled cleaning of vehicles, and in particular, for controlled cleaning of the interior of a vehicle.

### BACKGROUND

Internal cleaning of passenger vehicle operations at car wash locations have typically been the domain of manual laborers. This is due to the inherent high mix, dynamic environment for which these operations occur. Though external passenger vehicle washing has seen pretty standard implementations of automated solutions, the interior provides additional challenges. The interiors vary greatly across vehicles, they contain many more confined/tight spaces, and involve numerous different processes that often require wiping with a cloth, which involves a lot of force feedback and dexterity. Further complicating matters is that the presentation of the passenger vehicle is not often repeatable, so it may be difficult for legacy automation approaches to know with confidence where the features/surfaces to be processed are located in space, not to mention managing the different items that may be left in a vehicle that need to be managed or planned around or avoided. These and other deficiencies exist.

### BRIEF SUMMARY

Embodiments of the present disclosure provide a system for cleaning an interior of a vehicle. The system may include a robotic arm positioned outside of the vehicle. The robotic arm may include an end effector configured as a cleaning implement for cleaning a surface in the interior of the vehicle. The system may include a first camera configured to determine a position of the vehicle with respect to a reference point. The system may include a second camera configured to scan the interior of the vehicle. The system may include a first controller configured to create and/or modify a tool path to execute a cleaning operation, based on the scan, and to send instructions to the robotic arm to execute the cleaning operation in accordance with the created or modified tool path.

Embodiments of the present disclosure provide an automated method for cleaning an interior of a vehicle. The method may include determining a position of the vehicle with respect to one or more robotic arms positioned exterior to the vehicle. The method may include scanning a configuration of the vehicle to yield a configuration scan. The method may include identifying surfaces to be cleaned. The method may include creating and/or modifying a plurality of tool paths for the one or more robotic arms to clean the identified surfaces. The method may include controlling the one or more robotic arms to move along the created and/or modified plurality of tool paths and execute a cleaning operation in the interior of the vehicle

Embodiments of the present disclosure provide automated method for cleaning an interior of a vehicle. The method may include storing a plurality of images for a plurality of vehicles in a database to create a master data package. The method may include acquiring vehicle specific data from the master data package. The method may include scanning a configuration of the vehicle. The method may include aligning the acquired vehicle specific data with the scanned configuration. The method may include creating a process plan for execution of a plurality of cleaning operations. The method may include sending instructions to a robot to execute the plurality of cleaning operations based on the process plan. The method may include executing the plurality of cleaning operations in accordance with the instructions.

### BRIEF DESCRIPTION OF THE DRAWINGS

FIGS. 1A-1C illustrate a diagram of a system according to an exemplary embodiment.

FIG. 2 depicts an image of marker identification according to an exemplary embodiment.

FIG. 3 depicts a method for model generation according to an exemplary embodiment.

FIGS. 4A-4C illustrate segmented out geometrical regions with one or more tool paths according to an exemplary embodiment.

FIG. 5 illustrates a method of obstacle detection according to an exemplary embodiment.

FIG. 6 illustrates an image of initial registration via implementation of an algorithm according to an exemplary embodiment.

FIG. 7 illustrates an image of seat alignment according to an exemplary embodiment.

FIG. 8 illustrates an image of collision object detection according to an exemplary embodiment.

FIGS. 9A-9B illustrate an image of collision object detection according to another exemplary embodiment.

FIGS. 10A-10C illustrate feature acquisition according to an exemplary embodiment.

FIG. 11 illustrates an image of motion planning according to an exemplary embodiment.

FIG. 12 illustrates images for registration and obstacle detection in a vehicle according to an exemplary embodiment.

FIG. 13 illustrates a decision matrix for a configuration scanner according to an exemplary embodiment.

FIG. 14 illustrates example master scan data collected according to an exemplary embodiment.

FIG. 15 illustrates a method for seat registration according to an exemplary embodiment.

FIGS. 16A-16H illustrates images for pre-registered and registered interior vehicle portions according to an exemplary embodiment.

FIG. 17 illustrates an image of a tooling attachment according to an exemplary embodiment.

FIG. 18 illustrates an image of a component against a portion of an interior of a vehicle according to an exemplary embodiment.

FIG. 19 illustrates an image of a robot in motion according to an exemplary embodiment.

FIG. 20 illustrates an automated method for cleaning an interior of a vehicle according to an exemplary embodiment.

FIG. 21 illustrates an automated method for cleaning an interior of a vehicle according to another exemplary embodiment.

FIG. 22 illustrates a diagram of vehicle zones for cleaning an interior of a vehicle according to an exemplary embodiment.

FIG. 23A illustrates a diagram of robots for cleaning an interior of a vehicle according to an exemplary embodiment. FIG. 23B illustrates a plan view of a diagram of robots for cleaning an interior of a vehicle according to an exemplary embodiment.

FIG. 24 illustrates a schematic of a vehicle transiting through stages of interior cleaning according to another exemplary embodiment.

FIG. 25 illustrates a schematic of a vehicle transiting through stages of interior cleaning according to another exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the systems and methods disclosed herein. The description of embodiments should facilitate understanding of the systems and methods to such an extent that other implementations, not specifically covered but within the knowledge of a person of skill in the art having read the description of embodiments, would be understood to be consistent with an application thereof.

The systems and methods disclosed herein are configured to provide controlled cleaning of vehicles, and in particular, the interior of a vehicle. The implementation of the systems and methods disclosed herein provides advances in robotics technology, including the ability to reconstruct surfaces, identify features/surfaces, localize and register items to be processed, autonomous tool path planning and process planning based on presented information, and motion planning that includes coordination of external axes, with high fidelity collision avoidance, and represents improvements over implementations that, in addition to the above-identified deficiencies, are typically low margin and that have historically relied on low cost labor to realize the requirements of the internal cleaning operations. The solution described herein provides a guided autonomous solution, where a human may or may not be guiding the process, either quite minimally, or more so, depending on complexity and other considerations, to realize the idea of a reduction of manual touch labor that currently occurs on vehicles that enter a car wash bay, thereby reducing operational costs, and improving automobile throughput at high levels of quality. The systems and methods described herein are configured to meet rigorous throughput and cost requirements of the vehicle cleaning industry by employing a safe, effective, and efficient cleaning process within the footprint of standard vehicle wash facilities.

Also included in the solution, and in accordance with the systems and methods described herein, is the mounting, tooling, and/or fitting of the robots. In particular, one or more robots may be used to perform one or more commands, such as cleaning operations of the interior of a vehicle. The one or more robots may be positioned overhead and/or can be floor mounted. According to one embodiment, a robot can be mounted overhead and positioned to clear the open doors of a vehicle, and still be able to reach a floor of the vehicle. Without limitation and by way of example, a vehicle may refer to a car or a truck. Conventional robots, such as a Yaskawa HC20 robot with a 1700 mm reach may not be suitable. For instance, if this robot is mounted overhead at a height that would allow vehicles to pass safely below it, it would not be possible for the robot to reach the floor. Accordingly, a 2-axis gantry with a collaborative robot can be utilized. In particular, a 2-axis gantry system that is configured to both track and extend, vertically for a ceiling mounted robot, and horizontally for a floor mounted robot can be utilized. In some examples, this would extend far enough into the ceiling or wall so as to be out of the way of the vehicle, and out far enough to position the robot closer to the vehicle. In some examples, a larger non-collaborative robot, such as Yaskawa MH50 II-20, would allow the robot to reach into the vehicle, and for the vehicle to safely pass under it. In addition, the robot may be configured to reach into the footwell at a sufficient angle to avoid collision with the door of the vehicle. It is to be appreciated that other suitable configurations, such as a scara-type rotating linkage may also be employed to extend reach into a vehicle while keeping the robot out of the way. In addition, it is to be further appreciated that autonomous approaches (without limitation, through implementation of a simultaneous localization and mapping (SLAM) algorithm) may be configured to scan the interior of the vehicle and plan the trajectory of the tool path(s) in real-time, or in which autonomous robot manipulators may be configured to map out the interior of the vehicle to perform the cleaning of the interior of the vehicle.

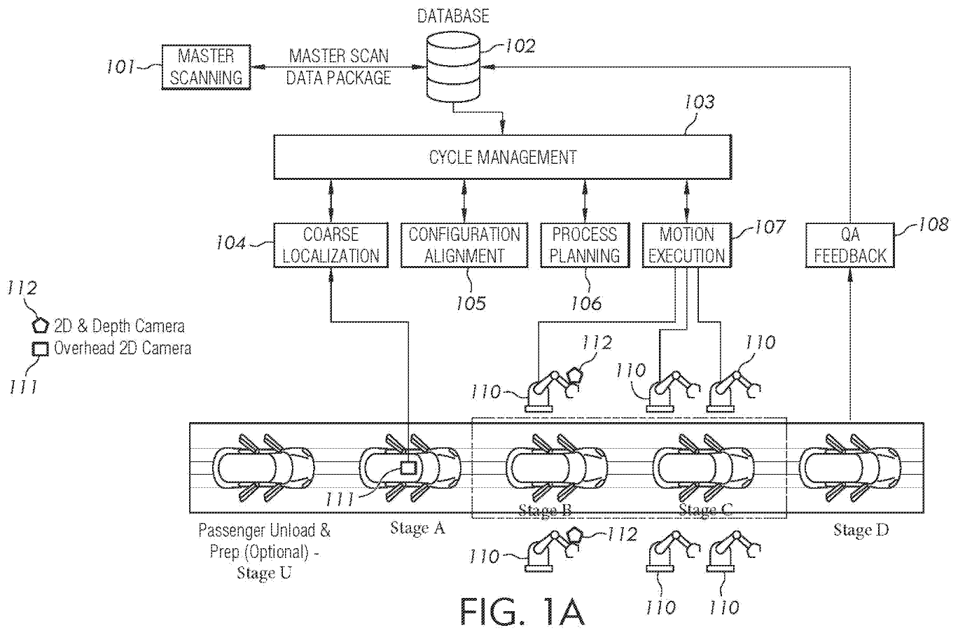

FIG. 1A illustrates a diagram of a system 100 according to an exemplary embodiment. The system 100 may be configured for cleaning an interior of a vehicle. The system 100 may include any number of the following components: master scanning 101, database 102, cycle management 103, coarse localization 104, configuration alignment 105, process planning 106, motion execution 107, and quality assurance feedback 108. The process planning 106 may be for desired operations, including spraying of cleaning solution onto vehicle interior surfaces, wiping of interior window surfaces, and/or vacuuming of seats and foot wells. The cycle management 103 may be configured to serve as the coordinator for sub-processes and tasking of specific automated operations.

FIG. 1B illustrates a diagram of a system 100 according to another exemplary embodiment. The system 100 may be configured for cleaning an interior of a vehicle. FIG. 1B may incorporate and reference any of the components as explained above with respect to FIG. 1A. FIGS. 1A and 1B illustrate a sequence of processing steps as a vehicle moves through the system 100. The system 100 may include any number of the following components: master scanning 101, database 102, coarse localization 104, configuration alignment 105, process planning 106, motion execution 107, quality assurance feedback 108, and scan, locate and query 109. The process planning 106 may be for desired operations, including spraying of cleaning solution onto vehicle interior surfaces, wiping of interior window surfaces, and/or vacuuming of seats and foot wells.

A “Master Scan” process can be conducted prior to the vehicle arriving at a facility, where a technician captures a high-resolution 3D scan of the vehicle's interior, in which the scan may be processed to produce a model-specific Master Scan Data Package (“MSDP”). Without limitation, this data package may include a file or plurality of files including 3D mesh models, process tool paths, and various other metadata. The MSDP is transmitted to a database 102, such as a local database, at the facility. This information can be transmitted to local databases at a plurality of facilities within a network, or can be uploaded to a cloud or cloud-based server in a computing environment and deployed via one or more containers so that each facility can pull information when needed. Thus, when the vehicle arrives at the facility, the vehicle is identified, such as through a license plate or VIN scanner, to determine a specific model of the vehicle as stored in the database 102. Alternatively, the MSDP creation process can occur at the facility just ahead of the cleaning operation. This process can be used for a vehicle that has not been seen before based on a set of rules relative to the generalizability of the data in the one or more databases relative to available master scan data packages. Additionally, the MSDP may include segmented features, such as consoles, door scans, and seats. The MSDP creation process may leverage a 3D scanner. The scanner collects data about various surfaces within the vehicle in order to recreate such surfaces of the vehicle to be processed during cleaning. In some examples, regarding car windows, the 3D scanner may be tilted to get into edges where the glass touches the door. At a minimum, the scanner must be configured to obtain the edges or corners of the windows of the vehicle.

The master scan may be configured to generate new or augment existing measurements for use in the creation of 3D maps of vehicle interiors, including obstructions which are not part of the originally produced vehicle. Preferable scanning method uses 3D time of flight cameras for high resolution and speed, but other scanning methods such as LIDAR or other available techniques can be used. Once captured, the scanned data may be transferred to and stored in a database 102 for retrieval by a robotic arm 110.

A VIN reader or scanning system may be configured to, as part of the vehicle identification, read VIN, or measure length, width, or wheelbase, or identify other distinguishing features of a vehicle for purpose of attributing the identifying characteristics to specific vehicle makes, years, and models. This data may be transmitted and stored in a database 102, which may contain interior and exterior information attributed to specific vehicle makes, years, and models and the database 102 may be configured to utilize this information to alert the robotic arms 110 to locate an interior 3D map for the relevant vehicle. The scanning system can be a handheld VIN reading system or linked to other camera-based systems, including but not limited to first camera 111 and/or second camera 112.

As depicted in FIGS. 1A and 1B, a plurality of stages exist for the system 100, and are sequentially depicted with respect to the vehicle. These include Stage U, Stage A, Stage B, Stage C, and Stage D.

At Stage U, any number of passengers may be unloaded for vehicle preparation. At Stage A, a camera 111 may be configured to inspect the vehicle to determine its approximate position on a conveyor belt 117 (Coarse Localization 104). This camera 111 can be a 2D camera or 3D camera, positioned overhead relative to the vehicle, and can capture one or more images. This measurement allows the system 100 to adapt a “Configuration Scan” robot path from the database 102 to match the vehicle's position. Stage B can include two robot-mounted cameras 112, such as 3D or depth cameras, to acquire one or more additional images. These cameras 112 may be disposed on opposite sides of the vehicle, such as left and right sides of the vehicle. In some examples, the arrangement of robotic arms 110 or manipulators may be symmetric, whereas in other examples, the arrangement of the robotic arms 110 or manipulators may be asymmetric. Without limitation, the robotic arm 110 may be a part of a robot. The robotic arms 110 at Stage B execute the Configuration Scan robot paths to position the cameras, which capture Configuration Scan data of the vehicle interior from several viewpoints in both the front and rear compartments (Scan, Locate, Query 109). This vehicle-specific scan is processed and compared against the MSDP. Then, the coarse vehicle alignment from Stage A is fine-tuned and tool paths are shifted, such as to account for front seat adjustments (Configuration Alignment 105), as well as any obstacles that may be observed in the Configuration Scan data. These obstacles are accounted for by treating them as collision objects, and motion planning is updated to account for these obstacles. In some examples, the tool paths may simply be truncated in certain instances, or the free space available for robot motion simply updated by the presence of the observed obstacle. Tool paths from the MSDP are aligned to the current vehicle position, adjusted to avoid detected obstacles, and converted to Robot Motion Paths (Process Planning 106). These computed paths are transferred to robot controllers to execute robot motion and to control process tooling (Motion Execution 107) at Stage C. In the provided example, four robotic arms 110 are utilized for Motion Execution; however, any suitable number of robotic arms 110 can be employed. At Stage D, one or more operators can enter the process to complete a final manual touch-up and inspection. At this stage, the operator(s) can enter feedback into the system 100 to identify any areas for improvement by later automated and/or manual processes (QA Feedback”).

As shown in FIGS. 1A and 1B, Stage A can be a separate station in which the Coarse Localization 104 is performed. The position of the vehicle at Stage A can be determined in about 10 seconds. However, in the present example, is not critical to the overall cleaning process time for the system 100 since it is conducted separately. The Configuration Scan process includes robot motions to several viewpoints in the front and rear compartments and could take 50% of the cleaning process time at Stage B. The remaining 50% of time at Stage B is available for cleaning processes, such as windows and door panels. The Configuration Scan may be managed by pulling in various image captures and merging the discrete point clouds into a single point cloud. This may then be registered to the master scan data via implementation of an iterative closest point algorithm that is specific to this application. The ICP algorithm may be configured to highlight differences between the MSDP scan data and the configuration point cloud data as obstacles, which may then be utilized for modifying the tool paths, such as by either clipping/truncating of tool paths (for example, in the case of a car seat), or as a collision object that is to be avoided for motion planning (for example, as a steering wheel), or a device (for example, a phone) holder that is protruding from the dash of the interior of the vehicle. Any object that is identified as not being part of the data matching the scan information in the master data package is treated as a collision object to be avoided, regardless of being a large object or a small object. Once the Configuration Scan is complete, the Configuration Alignment 105 and Process Planning 106 may begin and be completed prior to the vehicle arriving at Stage C. The Motion Execution 107 of cleaning processes, including but not limited to dash, console, seats, floor pans, windshield, may take 100% of the cycle time at Stage C. In some examples, it is understood that any portion of the Motion Execution 107 may occur at Stage B.

FIG. 1C illustrates a diagram of a system 100 according to another exemplary embodiment. FIG. 1C may incorporate and reference any of the components as explained above with respect to FIG. 1A and FIG. 1B. The system 100 may include a robotic arm 110, a first camera 111, a second camera 112, and a first controller 113. In some examples, the system 100 may also include a communication system 114, a second controller 115, a rail 116, a conveyor 117, a state machine 118, and/or any combination thereof. While single instances of the components are illustrated in FIG. 1C, it is understood that system 100 of FIG. 1C may include any number of components.

In some examples, a robotic arm 110 may be part of an interconnected robot system. The robotic arm 110 may be positioned outside of a vehicle. The robotic arm 110 may include an end effector. The end effector may be configured as a cleaning implement for cleaning a surface within the vehicle. Without limitation, the surface within the vehicle may refer to an interior surface of the vehicle. In some examples, at least one of the robotic arm 110 and the end effector may include a sensor that is configured to detect objects that are present inside the vehicle. In some examples, a plurality of end effectors of the robotic arm 110 may be configured specifically for vehicle interior cleaning operations. Moreover, a plurality of sensors incorporated into the end effectors and/or robotic arms 110 may be configured to detect the position of objects and obstacles in the vehicle interior in a manner that is robust and timely enough to allow for in-situ collision avoidance via robot control software algorithms.

Regarding the interconnected robot system, this may be configured such that a plurality, including but not limited to up to 4-sets of two robotic arms 100 may be positioned outside the openings of various vehicles, and the vehicles may be conveyed to a point where the interconnected robot systems are stationed. Two robotic arms 110 may be joined and mounted on a custom-designed cantilevered, pivotable track system allowing for each robotic arm 110 pair to move up and down and reach horizontally to enter the vehicle and address roughly one quarter of the interior vehicle space to be cleaned. Multi-axis robotic arms 110 may be selected for their compactness and ability to easily enter and exit the vehicle through the door opening, as well as for their payload, reach, and dexterity once inside the vehicle. The interconnected robot systems can include any number of robotic arms 110, which may be configured to move at higher speeds, or comparably sized collaborative robots, which may be selected for their built-in safety features. The interconnected robot systems may be positionally fixed at a location such that vehicles move to the location of the interconnected robot systems in order to be cleaned and thereafter move away from the system 100. Alternatively, the interconnected robot system may be configured to move along with a vehicle as the vehicle moves along a predetermined travel pathway. The robotic arms 110 of the interconnected robot system can be positioned such that they are affixed on either side of a vehicle to be cleaned, or the robotic arms 110 can be positioned overhead of the vehicle. Each of the interconnected robot system may include a robot programmable logic controller and graphical interface which links robot control software of the robotic arm 110 to the vehicle wash facility's conveyor control system, allowing for sensor driven or robot control software-driven, or control of interior cleaning line conveyor speed, acceleration, and vehicle placement. In some examples, the graphic interface may be configured to monitor the performance by the system 100. For example, the graphic interface may indicate a score for assessing how the cleaning of the interior of the vehicle, performed by the systems and methods disclosed herein, looked.

The first camera 111 may be configured to determine a position of the vehicle with respect to a reference point. In some examples, the first camera may comprise a 2D camera. The first camera 111 may be located above the vehicle. For example, the first camera 111 may be located at a position above a roof of the vehicle.

The second camera 112 may be configured to scan the interior of the vehicle. In some examples, the second camera 112 may be configured to detect a seat position, a steering while position, an object present in the vehicle, and/or any combination thereof. The second camera 112 may be positioned outside the vehicle. The second camera 112 may be coupled to the robotic arm 110. In some examples, the second camera 112 may comprise a 3D camera.

In some examples, the first and second controller 113, 115 may be configured to operate as a single controller. In other examples, the first and second controllers 113, 115 may operate as separate controllers. The first and second controller 113, 115 may be configured to control the execution of tool paths and coordinate the dissemination of tools and motion paths to each of the robotic manipulator controllers and peripheral hardware. The first controller 113 may be also configured to transmit the instructions to the robotic arm 110 to execute, based on the scanned interior of the vehicle by the second camera 112, the cleaning operation in accordance with the created tool path. In some examples, the tool path represents not only the location on the surface that a path is being applied for motion execution, but also contains information such as metadata that includes the process information, such as stand-off, tool angle or an angle range, and tool. This information may be represented in a MSDP tool file schema. In some examples, the scheme includes a format for the tool paths and requirements for the specific tool, which may be assigned to any candidate surfaces within the cleaning domain that is the interior of the vehicle. The second controller 115 may be configured to receive data from one or more sensors to mitigate collision.

The communication system 114 may be coupled to any number of the controllers 113, 115. In some examples, the communication system 114 may include a quality assurance feedback loop, as previously described above with respect to quality assurance feedback 108.

The database 102 may include a plurality of stored vehicle configurations. In some examples, the database 102 may contain relevant interior and exterior vehicle data and characteristics which can be constructed into a 3D map of a vehicle's interior. Data in the database 102 may be organized in a way which allows the data to be attributed to and retrieved by a vehicle's make, year, and model number. Maps can also reflect the 3D map of the interior as designed, as well as observed variations caused by objects, added features or items, or from other modifications to the vehicle. As explained above, the system 100 may be configured to generate or retrieve existing 3D maps of vehicle interiors for instructing and controlling the robotic arm 110 of robot system. The controllers 113, 115 may be configured to compare map to real-time sensor-collected data and, in the event of differences, make decisions about the appropriate path to take based on a set of rules and priorities. The controllers 113, 115 may be configured to document and update 3D maps and instructions in the robotic arm 110 of the robot system and the database 102 with the new data.

The system 100 has two primary episodes of robot control/guidance: First, when the vehicle is presented on the conveyor 117 to the robotic arm 110 of the robot system—for guiding the robotic arm-pair 110 inside the vehicle through the door opening. Second, once inside the vehicle, the controllers 113, 115 may be configured to manage the motion, movements, and workflow of the robotic arm 110 and end effectors to complete the cleaning cycle in a timely manner.

The system 100 may be configured to continuously update the database 102 and 3D vehicle maps based on measured efficacy of motions of the robotic arms 110, using algorithms to ‘learn’ and optimize/minimize the motion path and time required to enter the vehicle and conduct the work. The learning and optimization can be attributed to, without limitation, specific vehicle makes, years, and/or models; types of vehicles, such as four-door sedans, trucks, or the like; and/or to commonly observed alterations/obstructions within a vehicle interior (e.g., how to best navigate around a baby seat).

In some examples, a computer system may be configured to maintain the database 102, and physically or wirelessly connect to various input, output, and backup components of the system 100. The system 100 may be configured to provide data processing or computational support as needed. The system 100 can be connected to a network, such as the network described above, such that information stored therein can be accessed via the network at multiple locations, including locations along the same vehicle wash line, such as downstream of the scanning system, and including remote locations, such as at a vehicle wash located in different locations, including a different city and/or state.

The rail 116, such as a linear rail, may be located above and alongside the vehicle. In some examples, the robotic arm 110 may be configured to move along the linear rail 116.

The vehicle may be carried on a conveyor 117. In some examples, the robotic arm 110 may be configured to move along the linear rail 116 in coordination with a motion of the conveyor 117.

The state machine 118 may be configured to manage timing and coordination of a plurality of cleaning implements and system peripherals. The cleaning method and system disclosed herein includes two workflows: actions at an individual robot station, and steps required to fully process a vehicle as it transits through the various cleaning stages. In some examples, multiples of these workflows may be happening in parallel: for example, six robotic arms 110 and three vehicles at a time. The state machine 118 may be configured to track and direct sequencing of these parallel tasks. Each vehicle in the system 100 may be associated with a “vehicle task list” that is configured to define which tasks are required to fully process a vehicle. Without limitation, the tasks may include computation (motion planning), sensing (overhead location scan), robot motion (execute front driver door cleaning paths). The tasks may be executed in parallel (motion planning of various sub-paths) or in a sequence (motion execution requires motion planning to be completed). The state machine 118 may be further configured to process active vehicle task lists (for each in-process vehicle) to run each task on asynchronous background threads when the appropriate preceding tasks have been completed.

In some examples, the system 100 may include a safety system. For example, the safety system may be configured to utilize vision methodologies to sense when humans or other undesired obstacles are close to the interconnected robot system or end effectors of the robotic arm 110, resulting in a reduction in robot system force or halting robot activity. The system 100 may be designed to effectively accommodate feedback, measurement, and control specific to robotic arms 110. For example, the robotic arms 110 may be used which are designed with greater mass and payload, and operate at higher speeds than collaborative robots for a lower investment and improved operational efficiency. In some examples, barriers, such as hard barriers, may be placed to ensure non-workers do not approach or get near working interconnected robot systems. Barriers can be transparent curtain-wall like structures made of glass, acrylic, or polycarbonate, or fence-like structures, or walls.

Any of the components of the system 100 may be implemented as hardware and/or software. Without limitation, any of the components of the system 100 may include a processor and a memory that communicate with each other through one or more networks that may also be part of the systems 100 of FIG. 1A and FIG. 1B and FIG. 1C. While single instances of the components are illustrated in FIG. 1A and FIG. 1B and FIG. 1C, it is understood that system 100 of FIG. 1A and FIG. 1B and FIG. 1C may include any number of components. In some examples, a single processor may be configured to carry out any number of functions in accordance with the systems and methods described herein. In other examples, a plurality of processors may be configured to carry out any number of functions in accordance with the systems and methods described herein.

The processor may comprise an application specific integrated circuit and may be configured to execute one or more instructions. The processor may be part of a device, such as a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. The device also may be a mobile device; for example, a mobile device may include an iPhone, iPod, iPad from Apple or any other mobile device running Apple's iOS operating system, any device running Microsoft's Windows Mobile operating system, any device running Google's Android operating system, and/or any other smartphone, tablet, or like wearable mobile device. In some examples, the server may be configured as a central system, server or platform to control and call various data at different times to execute a plurality of workflow actions to perform one or more functions described herein. The one or more servers may contain, or be in data communication with, one or more databases.

The device can include a processor and a memory, and it is understood that the processing circuitry may contain additional components, including processors, memories, error and parity/CRC checkers, data encoders, anticollision algorithms, controllers, command decoders, security primitives and tamper proofing hardware, as necessary or desired to perform the functions described herein. The device may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

The memory may be a read-only memory, write-once read-multiple memory or read/write memory, e.g., RAM, ROM, and EEPROM, and the system of FIG. 1A may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programmed many times after leaving the factory. It may also be read many times. Exemplary memory types that may be used as memory include but are not limited to semiconductor firmware memory, programmable memory, non-volatile memory, read only memory, electrically programmable memory, random access memory, flash memory (which may include, for example NAND or NOR type memory structures), magnetic disk memory, optical disk memory, combinations thereof, and the like. Additionally, or alternatively, memory may include other and/or later-developed types of computer-readable memory.

In some examples, the network may be one or more of a wireless network, a wired network, or any combination of wireless network and wired network, and may be configured to connect to any components of system. For example, the network may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network may include, without limitation, telephone lines, fiber optics, IEEE Ethernet 902.3, a wide area network, a wireless personal area network, a LAN, or a global network such as the Internet. In addition, the network may support an Internet network, a wireless communication network, a cellular network, or the like, or any combination thereof. The network may further include one network, or any number of the exemplary types of networks mentioned above, operating as a stand-alone network or in cooperation with each other. The network may utilize one or more protocols of one or more network elements to which they are communicatively coupled. The network may translate to or from other protocols to one or more protocols of network devices. Although a network may be depicted as a single network, it should be appreciated that according to one or more examples, the network may comprise a plurality of interconnected networks, such as, for example without limitation, the Internet, a service provider's network, a cable television network, corporate networks, and home networks.

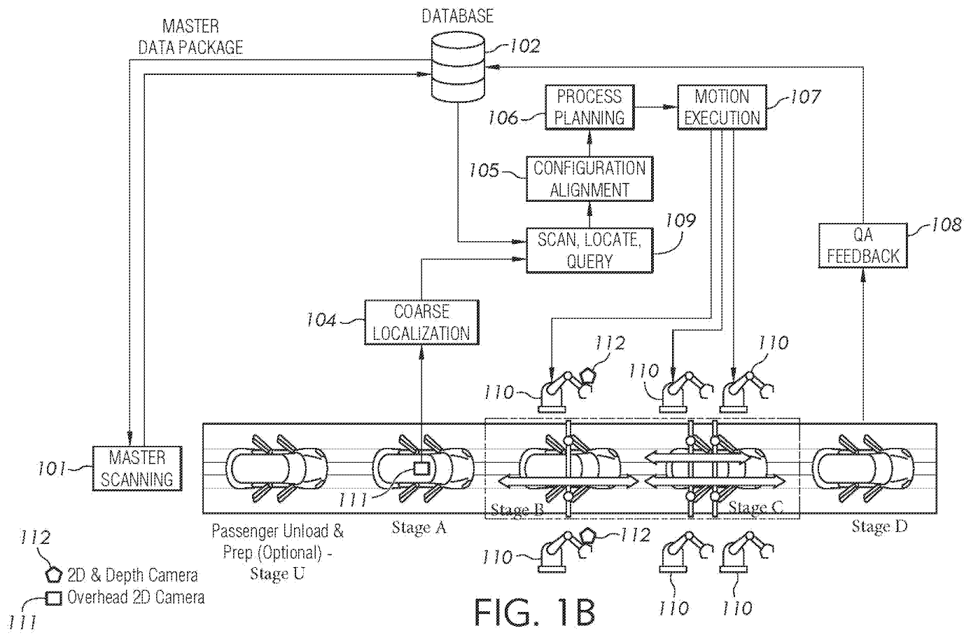

FIG. 2 depicts the use of reference point markers according to an exemplary embodiment. FIG. 2 may incorporate and reference any of the components and functions as explained above with respect to any of the figures described above. A plurality of markers 210 are positioned across various surfaces of the vehicle prior to scanning to facilitate high accuracy during 3D scanning. The markers 210 may include one or more stickers and/or magnets, which typically include an image of a black or white dot printed thereon. Without limitation, the markers 210 may comprise 3D printed markers, including but not limited to 3D prism printed markers. A 3D scanner uses these high contrast or high reflective images to determine its location relative to prior understood artifacts or imagery. These markers 210 provide the scanner with a consistent feature to track, and thus, increase accuracy and repeatability of 3D data as opposed to scanning features without markers. Narrow features, such as on the A-Pillar and B-Pillar of the vehicle, should use denser sticker/marker 210 coverage. In some examples, a “markers only” scan may be conducted first, then followed up by scanning the interior of the vehicle. Markers 210 may not be added to one or more exterior surfaces of the vehicle, including but not limited to one or more doors, until the one or more doors are ready to scan for collision detection. The markers 210 are generally placed manually by a technician across to-be-scanned surfaces prior to the master scan data collection. It is envisioned that future iterations of the master scan process will leverage a modified version of master scanning that will not use markers 210 placed on the vehicle and will be performed in an automated fashion, with master data collection happening on the line, as opposed to the current off-site implementation, decoupled from the main interior cleaning workflow. This is represented in the diagram in the fact that the master scan process is decoupled, only providing data to the database for subsequent leverage by the components running on the line.

For highly translucent or transparent surfaces (glass), a scanning spray is used. Without limitation, the scanning spray may include AESUB 3D™ scanning spray. It is understood that other scanning sprays may be used and that the scanning spray is not limited to such a scanning spray. The scanning spray may be applied, for example automatically or manually, to an exterior of the window while scanning the interior of the window to obtain accurate curvature so as to avoid unevenness of the applied spray. Regarding the application amount of the scanning spray, a light coating may be sufficient, and the scanning spray may evaporate on its own without requiring any cleaning or removal. In some examples, blue painter tape may be applied on interior surfaces of the vehicle that are difficult to reach via the scanning spray.

When scanning one or more doors or one or more portions thereof, it is preferred that the method includes scanning from the outside, which prevents surfaces sticking through each other if any door or portion thereof is moved slightly, e.g., a bump of the door interior may be done first, then it may protrude through scan of the exterior due to the swing and movement of the door. The one or more doors of the vehicle may be scanned separately from the frame and interior. This is to manage the situation where doors are bumped during scanning or move slightly. Overlapping geometry may be deleted after scanning, this avoids undesired overlaps when merging various scans.

Additional exterior data may be gathered for collision avoidance geometry. For instance, for regions of the vehicle that are not be subjected to robot tool path planning, or obstacle identification, or other discrete elements that influence robot motion planning within the vehicle, the general shape of the vehicle is captured for collision avoidance. This includes the exterior of the vehicle from A pillar to the front, and C pillar to the rear. For this process, a patterned blanket may be clipped to the vehicle and the scanning traverse speed by the operator was observed to be faster without repeating seen surfaces to perform detail image filling/completion. The software then takes the point cloud data that matches/aligns images due to the texture tracking of the blanket to create a uniform mesh surface that is sufficiently accurate to enable motion planning software to avoid those surfaces to prevent any sort of collision during motion execution. Models may be generated and merged from the various master scans of the various regions to form a single model, and this model may be decimated to reduce total size clean-up processes, which may be manual in some examples and may be automated in other examples, may be configured to eliminate holes, fill in regions with no data, in which it is undesirable for any robot to enter (for example, such as under one or more seats of the vehicle), and fix any overlapping as noted above. Thus, adding textured surfaces over portions of the vehicle that are only needed for collision avoidance may help accelerate scanning and processing and improve overall process flow. Moreover, partial car covers having markers printed, secured, or otherwise coupled thereon can be used.

Once a completed model is captured, segmentation may be initiated. This is the process of segmenting out portions of the scanned data that identify one or more features of interest. These include but are not limited to one or more seat bottoms, floor wells, and dash/console areas. The segmentation may be configured to drive a specific process type, such as the spray of a cleaning agent, or tool paths for a vacuum nozzle. In some examples, a trained classifier may or may not be included. While in some examples, a priori knowledge may be present, the MSDP has no a priori knowledge (for example, the MSDP may be yield the presence of a seat bottom, a dashboard, or the like.

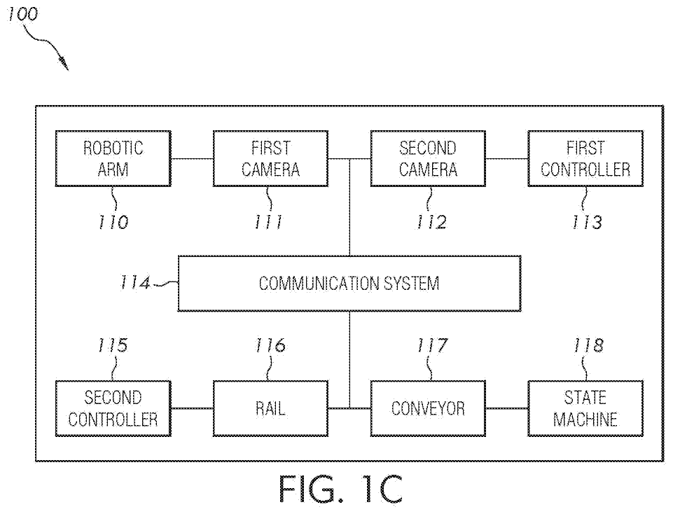

FIG. 3 depicts a method 300 for model generation according to an exemplary embodiment. FIG. 3 may incorporate and reference any of the components and functions as explained above with respect to any of the figures described above. At step 310, the method 300 may include applying target, or markers, on door frames and flat interior locations of a vehicle. At step 320, the method 300 may include applying a textured material, such as a blanket, to the hood and rear of the vehicle. Using the textured material provides tracking for the 3D scanner and significantly reduces the number of the markers applied to the vehicle. At step 330, the method 300 includes applying a scanning spray for black and/or shiny surfaces and windows. In some examples, the shiny and/or black vehicles may require the spray to collect data. The markers may show through a light coating of the spray. At step 340, one or more scans are collected, such as door frames, doors, hood and rear, and interior or the vehicle. At step 350, the method 300 may include aligning and/or merging the one or more scans. At step 360, the method 300 may include exporting the aligned and/or merged scans for processing. Thus, in steps 340-360, a model can be created by incorporating the individual scans and aligning the scans to create a unified single model. At step 370, the method 300 may include processing a mesh model, such as segmenting the mesh model, cleaning the mesh, and filling holes. At step 380, the method 300 may include decimating and additional processing the mesh. At step 390, the method 300 may include defeature for use in toolpath generation and/or saving for configuration scan registration. The system includes custom software utilities to perform application specific human guided, or autonomous, feature segmentation for path planning and the subsequent tool path planning, including the appendage of approaches and departures for each tool path, and their specific requirements. Graphical user interfaces to accompany these software modules will facilitate either human guided processes to facilitate the internal cleaning processes or fully autonomous based on rules-based and/or AI-based intelligence to realize broader generalizability of master scan data sets. Without limitation, scanning software and post-processing software may be configured to carry out the above features with respect to FIG. 3.

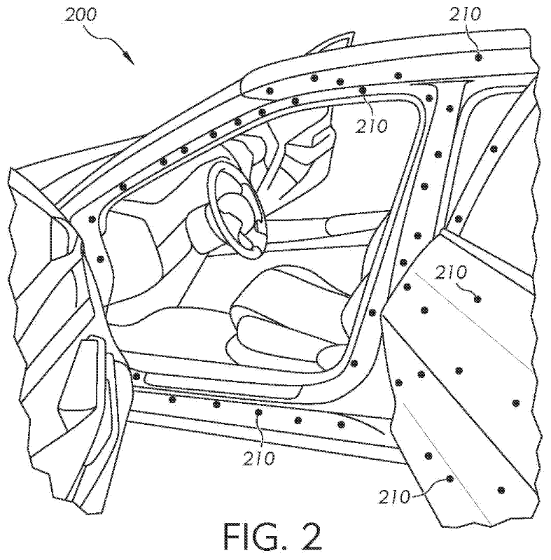

FIGS. 4A-4C illustrate segmented out geometrical regions with one or more tool paths according to an exemplary embodiment. FIGS. 4A-4C may incorporate and reference any of the components and functions as explained above with respect to any of the figures described above. In particular, FIG. 4A illustrates a front seat bottom segmentation 410. In some examples, the front seat bottom 410 may belong to a driver seat of the vehicle. In other examples, the front seat bottom 410 may belong to a passenger seat of the vehicle. FIG. 4B illustrates a rear floor segmentation 420, where the rear floor may be disposed behind the driver or passenger seat. FIG. 4C illustrates a rear seat segmentation 430, where the rear seat may be disposed behind the driver or passenger seat of the vehicle. Segmentation may be automated with one or more rules-based algorithms, one or more AI-based feature recognition algorithms, or any combination thereof. In some examples, segmentation may be human assisted. For example, a human-guided segmentation process may be utilized from the tools provided by the master scanning hardware's complimenting software. In other examples, segmentation may be automated. For example, autonomous segmentation tools may automate the segmentation process. In some examples, an application that includes instructions for execution on a client device, may be configured to enable, via a user interface, a guided experience for an operator to perform segmentation. This interface may enable simple click and classify with automated trimming to highlight only a portion, such as the seat bottom, for instance. In other examples, an automated workflow may be generated which has learned from prior human-guided segmentation and the data created to provide a workflow that is only supervised by an operator or a controller, with a level of automated quality assurances to flag one or more issues that are identified in the segmentation workflow. For example, via a touchscreen, an operator on the line can indicate if a region was not cleaned properly. This could be, for instance, a floor pan that was only 50% covered, leaving visible debris on half. The operator at the end of the robot region, that places objects back in the car and does other final prep, indicates the region not cleaned appropriately. This flags the MSDP, as well as the associated configuration data, and sends a notification for review of root cause. Early iterations can be reviewed by a technician, either for that site, or first available that has access to the data, and an update to the data package will be made. Work instructions to the prep crew can be updated if the lack of cleaning was due to an obstruction that was left in the way that could be simply moved. Additionally, generalizability across model types can be improved where multiple instances of truncated process paths are observed for a smaller vehicle, permanently updating or flagging for a technician review, to make a model specific update for improved performance on subsequent presentations of the vehicle at future sites.

During tool path planning, tool paths process steps may be configured to plan desired tool paths on as-presented master scans based on application of one or more rules entered by the user for the specific process. The one or more rules may include, but are not limited to, tool offset from the target surface, work and travel angle, as well as raster spacing. Though a mesh model may be of sufficient quality, a primitive can be inserted over the surface, such as at a predetermined z-offset distance, to provide a more consistent motion path for a subsequent motion plan. For example, if the mesh model includes highly tufted seats, a tool path motion using the mesh data could be overly complex, which adds unnecessary time to the process and may not lead to any improvements in cleaning performance. Thus the use of a primitive or sets of primitives may provide for more simple motion profiles to be planned and executed, thereby increasing computations performance and motion consistency. In some examples, auto-fit of a primitive just above the target surface may be human-guided. In other examples, the auto-fit of a primitive just above the target surface may be automated. A region is initially segmented, once surfaces are classified/identified, the primitive is fit, e.g., a plane that may be a 2D polygon, then subsequent raster paths are planned on the plane as opposed to directly onto the mesh. The output mesh from the scan, the identified regions that are segmented, collision geometry, and the tool paths for the target processes may constitute the MSDP. In some examples, tool paths may be applied directly to filtered mesh surfaces and additional filtering via leverage of a cartesian motion planner to provide refined tool paths based on the actual mesh surface may be leveraged, so as to reduce reliance on primitive fitting and allowing for improved tool following in execution.

Understanding when a master scan data package is required is used in implementing the systems and methods disclosed herein. For example, it is reasonable to say that if there is an MSDP, for a 2020 Toyota Camry, one may not need to be created for a 2021 Toyota Camry. This concept may be referred to as “generalizability” and is used to define how much of the data creation occurs over the various types of vehicles that may enter the vehicle wash operation. In general, it is believed that MSDPs may be shared across a subset of a type of vehicle, such as noted across the Camry line for at least a finite set of model years. Ideally, and as the system 100 progresses in capability, a broader range, such as full sized 4 door sedans, may be handled that takes into account managing variations such as seat width, similar to how obstructions would be managed by simply clipping tool planned tool paths. In some examples, the aforementioned generalizability may take into account notations on executed tool paths on the line to help inform whether any number of variations of an MSDP for a future vehicle in the same line (continuing with the above example, a 2025 Camry), is needed.

The MSDP may include detailed surface models, segmented out regions of the interior, collision modeling of surfaces, and specific tool paths on the segmented surfaces that are relevant to the desired process for execution. In some examples, segmentation may be human assisted, e.g., a human may input information into the client device, such as highlight an area (such as surfaces, dashboards, or seat bottoms) via the application comprising instructions for execution on the client device which may identify it as a given region, such as a dashboard. In other examples, these regions may be autonomously identified either via a rules-based algorithm, an AI-assisted semantic segmentation algorithm, or any combination thereof that is configured and optimized for automotive interior surfaces. Once segmentation has taken place, tool path planning adhering to the rules for the specific process may take place. Once tool paths are approved, or a quality assurance which leverages feedback from end of line operators, they may be uploaded to the MSDP database, which may be a cloud service to enable MSDP information be leveraged by any site that has access to the data. Having data in the cloud and collecting information from sites on how MSDP is both generalizable, and how it performs enables richer capability for optimization via learning, which may further leverage the cloud infrastructure that is leveraged, further reducing the amount of master scanning that has to take place over time and thereby mitigating the need for storage and improving overall system efficiency.

Operations may be configured to run “on the line” even at first deployment. The cycle management coordinator may include a state machine 118 that is configured to handle the timing and coordination of developed sub-modules and interaction with components of the system 100. This may include the launch of configuration scan and alignment, receiving the updated information, and providing the updated tool path offsets to the motion planner. Specific motion plans are assigned to specific assets and then, in a coordinated fashion, dispatched to the specific robot on the line, utilizing the specific hardware with the specific process recipes.

The configuration scan and alignment is the process that the vehicle to be processed is located on the line and is matched to the target or selected MSDP in the database. Information may be acquired about the vehicle that is entering a bay of a car wash, and this acquisition may be obtained through existing car wash infrastructure. The appropriate MSDP is then acquired, and the configuration scan and alignment process may be initiated. An overhead camera, such as the overhead 2D camera of FIG. 1, determines the coarse position of the vehicle on the belt, from here, with doors in the open position, and the robots in a backed away position, clear of the doors, an initial image is captured, focusing on the door jamb. Over the vehicles analyzed thus far, door jambs have been the most consistent feature to locate on the vehicle for launching the process; however, other vehicle features can be used in addition to or in place of the doorjamb. For instance, the pillars of the vehicle frame are typically not changed through customization and thus, are candidates for localization.

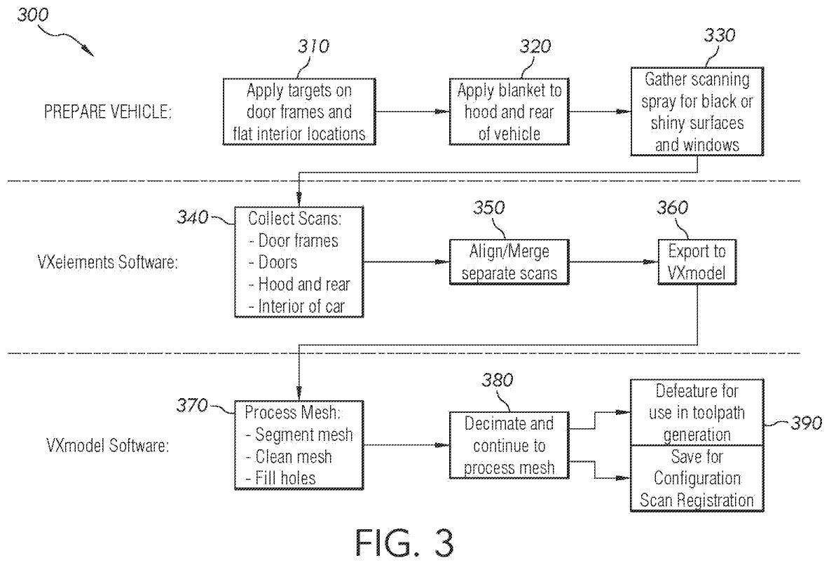

FIG. 5 illustrates a method 500 of obstacle detection according to an exemplary embodiment. FIG. 5 may incorporate and reference any of the components and functions as explained above with respect to any of the figures described above. At step 510, the method 500 may include providing an initial alignment. In some examples, this may include aligning a car body master scan to a front door jamb configuration scan, in which the consistency of the shape of the door jamb is leveraged. The car location transform may be outputted. At step 520, the method 500 may include applying an alignment transform. In some examples, the alignment transform from step 510 may be applied to one or more seat master scans. As a consequence, the one or more master seat scans is put proximate the actual seat position in the configuration scan. At step 530, the method 500 may include refining seat alignment. In some examples, a refined alignment of the one or more seat master scans is performed to the interior front configuration scan. This results in final seat positions that are much closer to the seat in the configuration scan. Additionally, this alignment step restrains the movement of the seat to match up the actual seat's degrees of freedom. The location of the seat may be outputted. At step 540, the method 500 may include detecting one or more obstacles. In some examples, a point cloud of detected obstacles can be generated from the discrepancies between the configuration and aligned master scans.

Regarding step 510, a method using an iterative closest point (ICP) algorithm is implemented and configured in order to align the car body master scan to a configuration scan that includes the geometry of the front doorjamb. The door jamb area was selected because it provides consistent geometric features that are helpful for registration. This registration result provides the location of the vehicle body and seat relative to the configuration scan. After that, a subsequent registration is performed to locate the seat position more precisely inside the vehicle. In some examples, the seat master scan may include two separate mesh models, such as, the bottom and backrest, aligned independent of each other. After aligning the car body and seat, the algorithm may be configured to remove the geometry that is common between the master and configuration scans and labels what remains as an obstacle. This creates a tiered ICP algorithm implementation that refines detailed alignment after first bulk alignment. For example, an ICP algorithm implementation, such as in MeshLab, may be configured to select any number of common points between the master and configuration scans, in which the ICP algorithm may be configured to then make any adjustments for final alignment. It is understood that other algorithms may be configured in lieu of MeshLab.

By aligning a master scan to the configuration scans, an application can be created that allows for determination of the vehicle location. In addition, seat positions may be accurately located and obstacles may be identified that keep the robot from reaching certain areas.

Without limitation, the obstacles may include an umbrella, a device mount (such as a phone mount), a drink cup, a jacket, an infant car seat. During testing, black, metal coffee mugs were often barely visible using a 3D camera (such as a Zivid™ camera), whereas a depth camera (such as a RealSense D455™ camera) provided better recognition of the black, metal coffee mug. It is understood that other types of suitable cameras may be implemented. In addition, to make up for the smaller field of view, two configuration scans can be combined when using the 3D camera.

To simulate a production system condition, an offset may be applied to the configuration scans. For example, a 0.2 radian (˜12 degree) and 0.1 m offset may be applied to configurations scans.

Initially, a view of the door jamb of the vehicle may be collected. This may comprise collecting views of both front and rear doorjambs. Then, a plurality of views of the interior through the front door are collected. Without limitation, this may include collecting three views. For each of the plurality of views, the following process may take place: collecting a configuration scan with no obstacle; adjusting the seat and/or adding an obstacle; and collecting the configuration scan. If the seat is adjustable, a plurality of seat positions, such as three seat positions, may be collected. After the views of the interior through the front door are collected, a plurality of views of the interior through the rear door may be collected. As with the interior through the front door view collection, this may include collecting three views of the interior through the rear door. For each of the plurality of views, the following process may take place: collecting a configuration scan with no obstacle; adjusting the seat and/or adding an obstacle; and collecting the configuration scan. If the seat is adjustable, a plurality of seat positions, such as three seat positions, may be collected.

In some examples, inputs for the following may include: for master scans, vehicle body without seat and steering wheel, seat bottom, and seat backrest; for configurations scans, front doorjamb, front interior (several views captured at various seat positions and with obstacles), rear interior (several views captured with different obstacles), and rear door jamb (optional); for configuration parameters, alignment constraints and obstacle detection. Outputs included: location of the vehicle body; location of the seat bottom and backrest; obstacle 3D point cloud; registration metric including a match percentage (which may measure number of common points between the master and configuration scans).

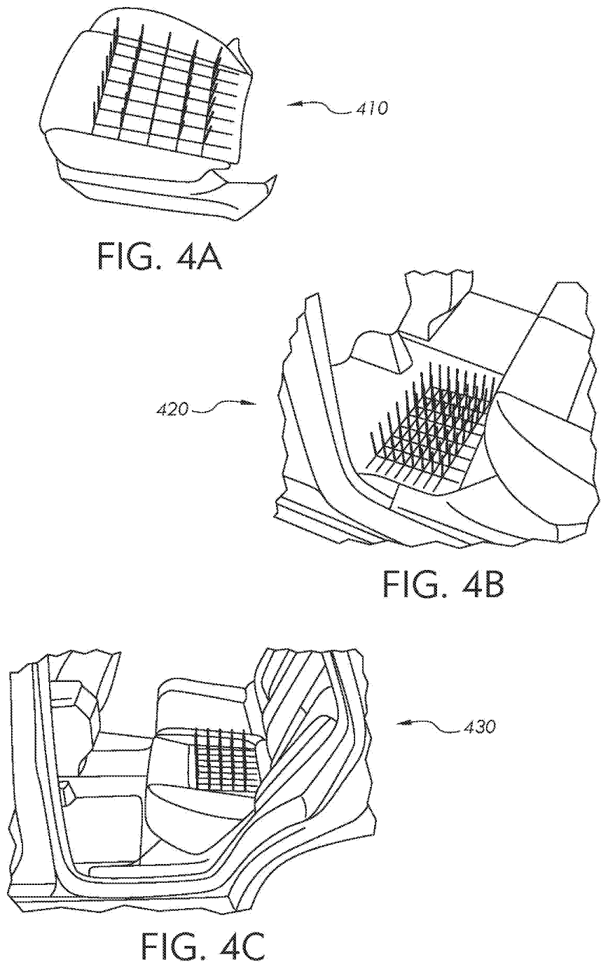

FIG. 6 illustrates an image 600 of initial registration via implementation of an algorithm according to an exemplary embodiment. FIG. 6 may incorporate and reference any of the components and functions as explained above with respect to any of the figures described above. As explained above, the algorithm may comprise an iterative closest point (ICP) algorithm. The portion 610 may represent a configuration before alignment, whereas the portion 620 may represent a configuration aligned with master data.

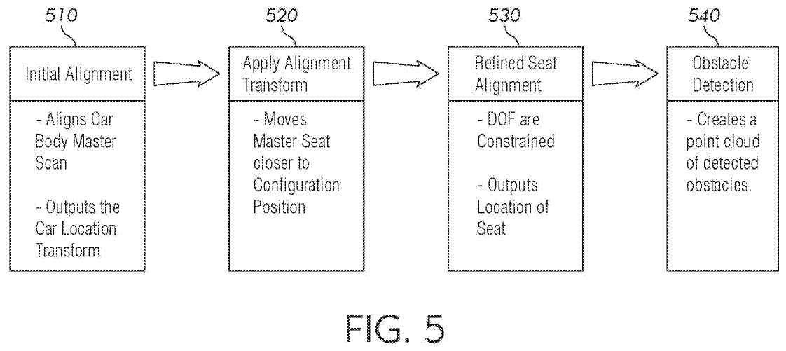

FIG. 7 illustrates an image 700 of seat alignment according to an exemplary embodiment. FIG. 7 may incorporate and reference any of the components and functions as explained above with respect to any of the figures described above. For example, the seat may be identified 710 in the configuration data and the pre-registration data (from the master data package) and is aligned to the observed seat in the configuration scan 720.

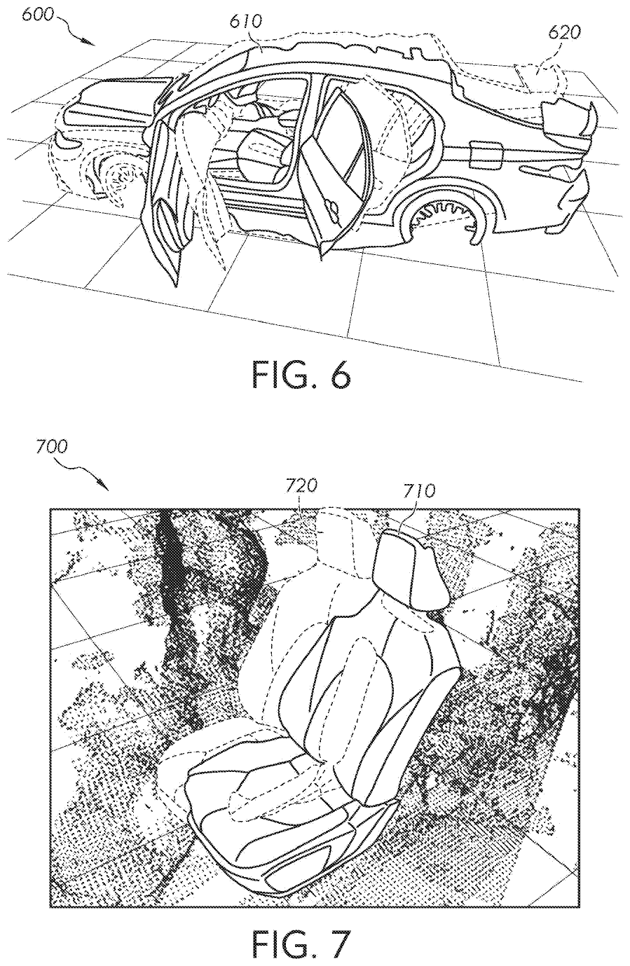

FIG. 8 illustrates an image 800 of collision object detection according to an exemplary embodiment. FIG. 8 may incorporate and reference any of the components and functions as explained above with respect to any of the figures described above. For example, any unregistered features that do not have a match to the master data in the configuration data may be identified as obstructions. As illustrated in FIG. 8, these obstructions may appear inside the vehicle as denoted 810. The obstructions 810 may be treated as collision objects for robot motion planning. For any number of items that appear in the console, or vehicle seats, tool paths may be clipped or truncated to omit tool paths that are within a predetermined distance, such as 1 cm to 4 cm depending on volumetric considerations of the region being processed, within the motion planning with regards to the avoidance of collision objects.

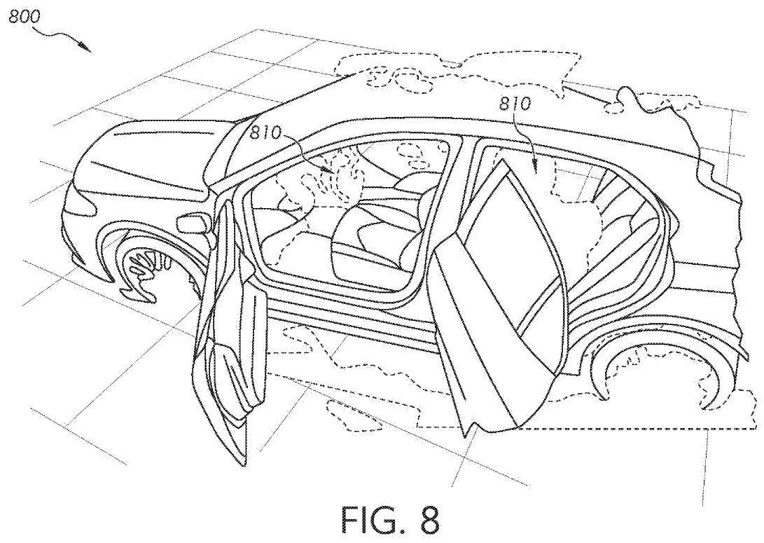

FIGS. 9A-9B illustrate an image 900 of collision object detection according to another exemplary embodiment. FIGS. 9A-9B may incorporate and reference any of the components and functions as explained above with respect to any of the figures described above. For example, in FIG. 9A, a vehicle seat is identified as a collision object 910. The collision object 910 may be located in the rear portion of the vehicle but is not limited to such positioning. In FIG. 9B, the image 900 illustrates the actual physical vehicle seat 920 that is identified as the collision object 910. Tool paths may be altered that would normally be planned for execution underneath the vehicle seat, thereby only planning an operation, such as the vacuum operation, on the rear seat that is exposed up to the predetermined zone relative to the collision object, in this case the vehicle seat. Although a vehicle seat 920 is depicted in FIG. 9B, it is understood that any number and type of other objects may be detected and is therefore not limited to such.

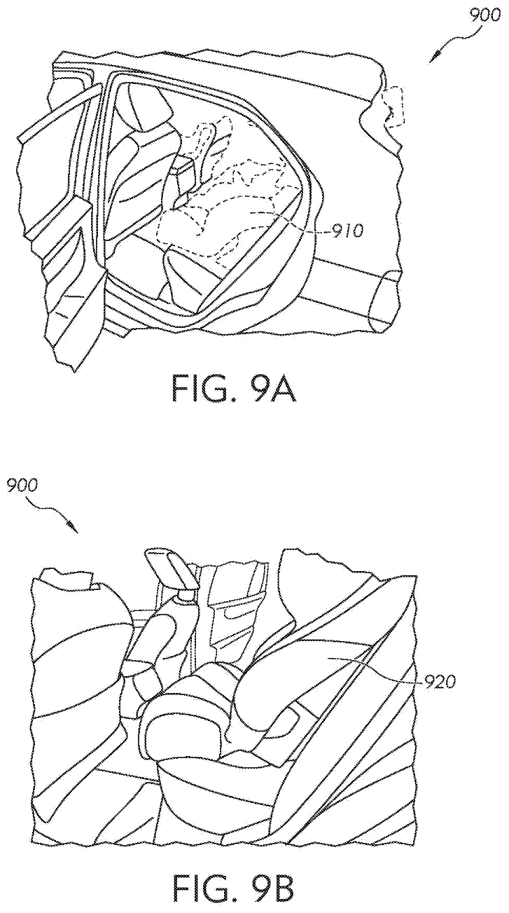

FIGS. 10A-10C illustrate feature acquisition according to an exemplary embodiment. FIGS. 10A-10C may incorporate and reference any of the components and functions as explained above with respect to any of the figures described above. In some examples, coarse vehicle location is required prior to initiation of any configuration scan, as illustrated in FIG. 10A. For example, this is implemented utilizing an overhead camera, such as the overhead camera, that that is configured to identify the extents of the width of the vehicle and find the vehicle doors using image analysis algorithms based on pixel contrast. In some examples, the configuration scan may be performed by the overhead camera, such as a depth camera, that is mounted to a wrist portion of a robot manipulator. In this manner, the overhead camera may be configured to find coarse alignment 1010. As illustrated in FIG. 10B, the initial image acquisition, such as a first image 1020, for the first registration is backed away from the vehicle, to capture the door jamb, clear of the doors. For example, this may serve as the capture of the initial doorjamb. As illustrated in FIG. 10C, a second image 1030 may be taken just outside of the opening of the vehicle doors but positioned by the robot within the envelope of the doors. In this manner, one or more interior features are acquired. Internal features acquired are, but not limited to, seats (all interior seats, front and back, and bottom and back rest, accounting for position), visible floor pans, console, dash, steering wheel, all windows, rearview mirror, seat belts that may obscure door opening, objects left in the vehicle, which may include, but not limited to, jackets, umbrellas, car seats, boxes (tissue to items that are similar to standard moving boxes). Objects that do not match to the configuration scan will automatically be treated as collision objects. If they obscure tool paths, the tool paths will be truncated within the allowable collision avoidance tolerance defined for that object class/region. In some examples, a plurality of additional images may be required. For example, up to two additional images may be acquired to fully capture footwell and seat detail information. However, the intent is to optimize based on observation analysis as the images are acquired so as to reduce the necessity of multiple image acquisition, reduce the need for system storage, and also improve the processing efficiency of the system. In some examples, the amount of time available may be on the front of line robots to tolerate the time to acquire images for processing, which may be in the order of seconds. While other cameras, such as a 3D camera, may be utilized for image acquisition, the depth camera is preferred due to improved field of view characteristics and the quantity of information obtained from a single shot. In some examples, the systems and methods disclosed herein may be camera agnostic, however specifications for the particular camera may drive different behavior of the system, such as where the robot positions the camera for the image acquisition and/or how many images are acquired.

Prior to sending instructions to the robot for execution of one or more cleaning operations, a process plan is created. From the prior operation, the system may have tool paths aligned to the frame of the robot relative to the vehicle. However, motions that are coordinated with the motion of the vehicle on a conveyor, for example, are planned as well as approaches and departures for the different processes, any tool changes and the transitions from free space (joint space) motion to cartesian (tool path) motion. In some examples, this process planning pipeline for the management of cleaning tasks inside vehicles may comprise: sequencing of robot planning tasks for the completion of a series of cleaning toolpaths (For example: Using planning frameworks; defining planning instructions using YAML files, this is a human readable configuration format that may be updated via a user interface, to allow tuning by technicians; sparse planning of cartesian trajectories; implementing an algorithm, such as dijkstra's shortest path graph search algorithm, to plan robot trajectories for cartesian paths using sampler based approach to more quickly find the configuration for the various poses along the cartesian path and edge evaluators. In some examples, the edge evaluator may account for tool speed limits, this is used by software tools to determine if a move between two consecutive points does not exceed the maximum allowed tool speed. The planning instructions program, written in YAML file format, may be configured to define sequence of free-space and cartesian toolpath planning instructions, thus supporting two kinds of planning instructions. The cartesian toolpath instructions may be configured to specify properties, such as tool standoff, approach and retreat distance, transformations, and coordinate frame of reference. For example, each instruction may be configured to specify a profile for each step in the planning process. Tool path planners may be configured to facilitate optimal configurations of the manipulators in the motion planning of cartesian tool paths. In some examples, other tool path planners may be used. Adding the ability to enable technician configuration enables this to be optimized for the specific application. From this point, the output of the software tools may be fed as a seed into an optimization pipeline to refine the manipulator free space motion based on defined constraints. These may be defined by acceleration or torque limitations defined by the system 100, or may also be adjusted based on technician and end-user end of line feedback on performance. Further performance enhancements may or may not be realized by the inclusion of a reinforcement learning actor as a seed for the optimization-based motion planning.

The systems and methods described herein employ process planning 106. Process paths for various processes of interest (including but not limited to applying a solvent or spray or wiping on any number of vehicle interior surfaces) may have a unique transition to departure, that is coordinated with other paths for completion within a given time frame. For example, the process paths may be configured to be completed within 80 seconds, which marks a departure from domains which are not time-constrained. In some examples, the systems and methods described herein may be implemented in an existing car wash workflow, where a vehicle may be configured for conveyance along a belt in a car wash bay. Additionally, or alternatively, the systems and methods are applicable to stationary vehicles in which the various process steps can be moved into place and conducted in sequence. In other words, the interior of the vehicle may be cleaned according to the systems and methods described herein while the vehicle remains still, either on or off the conveyor belt. Further still, the systems and methods can be employed in a car wash workflow using a combination of moving and unmoving stations. The systems and methods described herein may be generalizable in that there exists the ability to train a model and perform one or more process paths with limited data that is collected. The systems and methods are configured to adapt and modify execution of these process paths based on the limited data acquired, which can avoid the need to create a master scan data package for each car configuration.

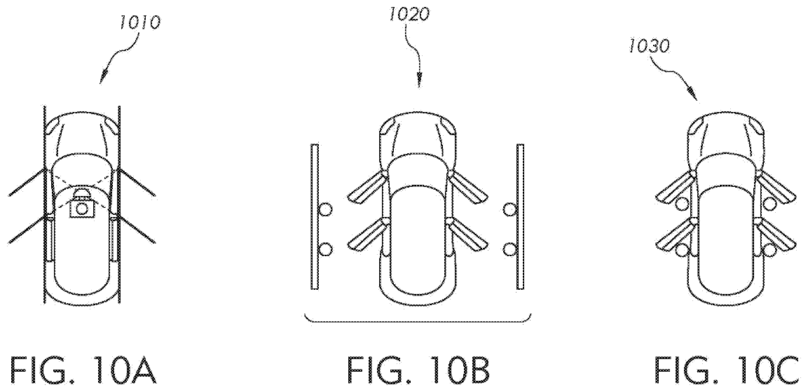

FIG. 11 illustrates an image 1100 of motion planning according to an exemplary embodiment. FIG. 11 may incorporate and reference any of the components and functions as explained above with respect to any of the figures described above. As the process planning process is initiated, the motion planning also incorporates the external axes, in this case a linear rail as well as a rotational compound rectangular prism structure to position the base of the robot nearest to the opening from above the vehicle. This concept moves the robots at the same rate of the vehicle moving on the conveyor; thereby, from the robot motion planning perspective, the vehicle appears stationary. Commands, such as one or more motion commands, along the rail may then be coordinated as plus or minus the velocity of the belt. By way of example, the belt speed may range from 0 feet per second to 0.5 feet per second. In some examples, the belt speed may comprise 0.3 feet per second. A motion planning algorithm may be configured to parse a planning program and toolpath files to then plan the corresponding robot trajectories. During operation, the motion planning algorithm may be configured to return a sequence of trajectories for the program files. The sequence of planned robot trajectories may be sent to a 3D visualizer for the robot operating system framework (such as rviz) for viewing, and a display may be configured to allow further inspection of the trajectories. Without limitation, this may include the free space motions to enter the vehicle, the approaches and departures for the tool paths for the various processes, and the cartesian paths for the specified processes. This may further include the optimized sequencing of the tasks relative to the time permitted for the given tasks. In some examples, planning time may be vastly reduced by using pre-computed trajectories. FIG. 11 depicts the door skin spraying process which is launched after configuration scan and subsequent motion planning.

The motion planning algorithm, in order to plan a new trajectory, may be configured to utilize toolpath processing; cartesian planning; optimization-based free-space planning; and post-processing.

In tool path processing, changes to the original tool path may be applied prior to planning. For example, this may include up-sampling or down-sampling waypoint count, etc. In Cartesian planning, a planner may be configured to obtain valid robot positions for toolpath points as allowed by the specified tool constraints. In free-space planning, this may be used for planning a free-space move from a most recent robot position to a start of the cartesian robot trajectory. Under post-processing, time values may be computed for trajectory waypoints so as to move the tool at a desired speed while at the same time adhering to the speed limits of the robot.

The steps above can use its own set of parameters, which can be specified in “profiles.” These profiles allow to easily load a different set of parameters in order to test how the results change.

A robot trajectory executor may be configured to execute robot free space and car cleaning tool path trajectories in the proper order, monitor the vehicle position, via a node (instantiated software code that performs a specific function) that tracks via external measuring or belt encoder monitoring, or a combination of both, to actively command a robot linear rail and the manipulator when the car is within the working envelope (reach) of the robot; and send back the robots to the start/initial position when the robot has completed the provided trajectories.

The sequence of planned robot trajectories may be sent to the visualization on the user interface of the client device for viewing, along with the option to halt or approve and send to the industrial robot controller for execution. In some examples, the display of the user interface of the client device may be configured to allow for further inspection of the trajectories, and the instructions for execution may be aborted or may be re-planned after operator intervention. The solution enables for the storage of successfully executed trajectories, which enables further optimization as the solution matures, up to including a reinforcement learning implementation for the optimization of industrial application trajectories. Thus, the database includes successful trajectories and the specific data set that informs the reinforcement learning implementation.

Once the process plans and motion plans are complete, including coordination of external axes that are complete and either simulated and approved, or approved via one or more algorithms, these motion plans are converted to native industrial robot controller software program language and transferred to the specific robot controllers for execution. A programmable logic controller (PLC) may be configured to coordinate the call of the specific programs for execution and act as a master of the hardware components of the system. A device, including but not limited to an industrialized personal computer, that contains the developed software may be configured to interact with the PLC to facilitate the coordination of the hardware assets. Once the desired processes are executed, the vehicle may depart the robotic operational area and thereby complete the process. In some examples, an operator can review the work performed and input via a touch screen of a device, including but not limited to a mobile device, information indicative of whether any rework was performed or assess if regions were skipped that possibly should not have been skipped. A skip may refer to a scenario where there was something within the vehicle that did not align between configuration data and master data. This results in collision geometry and may then remove the impacted/obstructed tool paths, when then results in the region not being processed. This data may be utilized for continuous improvement by adding annotations to the MSDP.

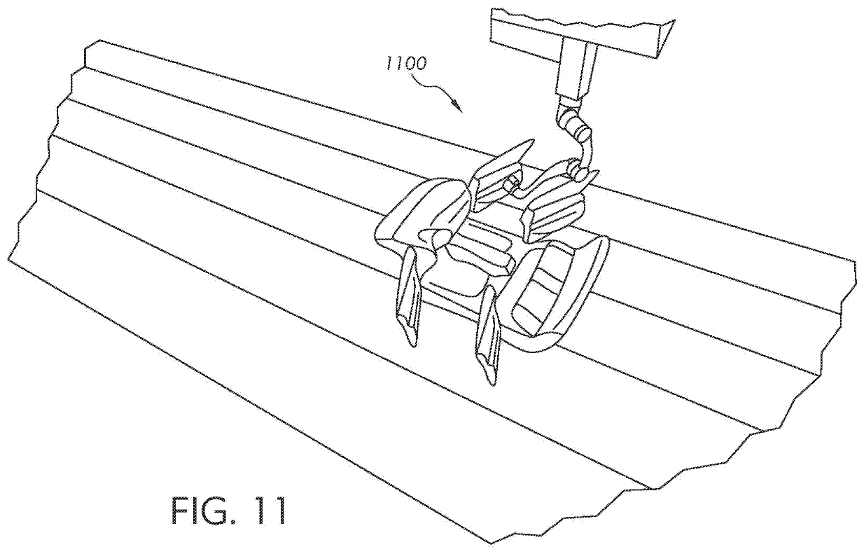

FIG. 12 illustrates images for registration 1210 and obstacle detection 1220 in a vehicle according to an exemplary embodiment. FIG. 12 may incorporate and reference any of the components and functions as explained above with respect to any of the figures described above. In some examples, this process may be generalized to different trim types.

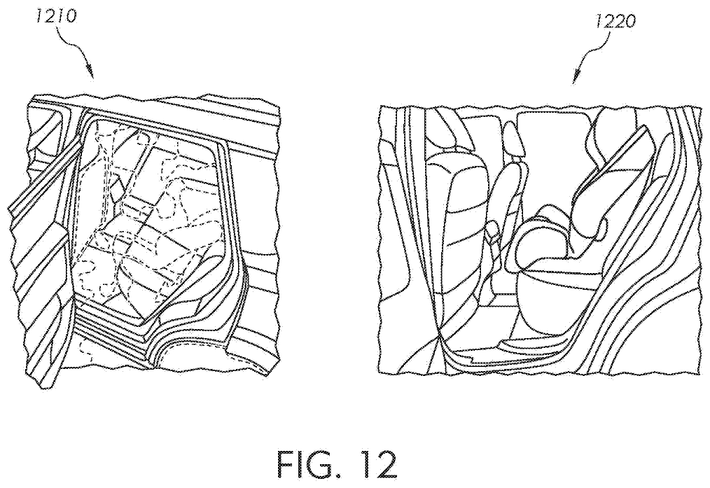

FIG. 13 illustrates a decision matrix for a configuration scanner according to an exemplary embodiment. FIG. 13 may incorporate and reference any of the components and functions as explained above with respect to any of the figures described above. In some examples, the Zivid Two™ camera or the Intel RealSense D435 may be used. The selection of a particular type of 3D sensor is based on consideration of a plurality of factors, including Field of View, Scan Time, Scan Quality, Performance relative to this application's registration requirements, and impact on solution deployability at scale. The consideration of the plurality of these factors were based on quantitative testing on representative surfaces and collected output aligned to a known condition.

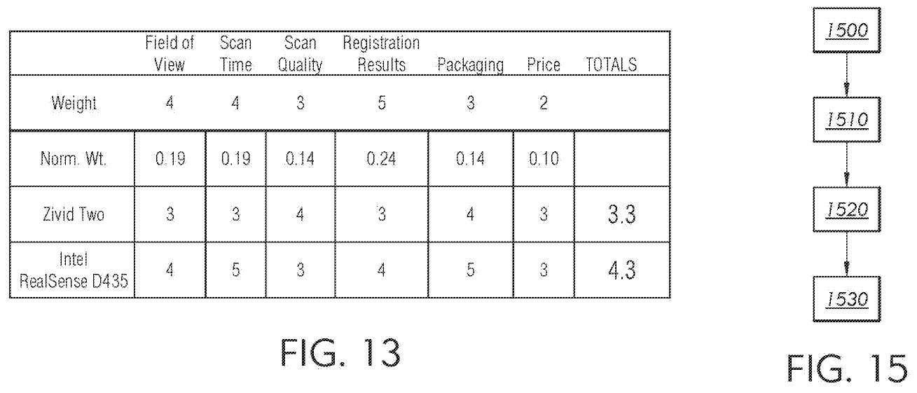

FIG. 14 illustrates example master scan data collected according to an exemplary embodiment. FIG. 14 may incorporate and reference any of the components and functions as explained above with respect to any of the figures described above. In some examples, this data 1410, 1420, 1430, 1440, 1450, 1460, each depicted as master scan data, may be collected may be from a variety of types of vehicles, including but not limited to Hyundai, Nissan, Toyota, Chrysler, and Dodge cars, SUVs, or Trucks. It is understood that master scan data may be collected from other vehicles and models, and as such are not limited to collecting data from only these types of vehicles.

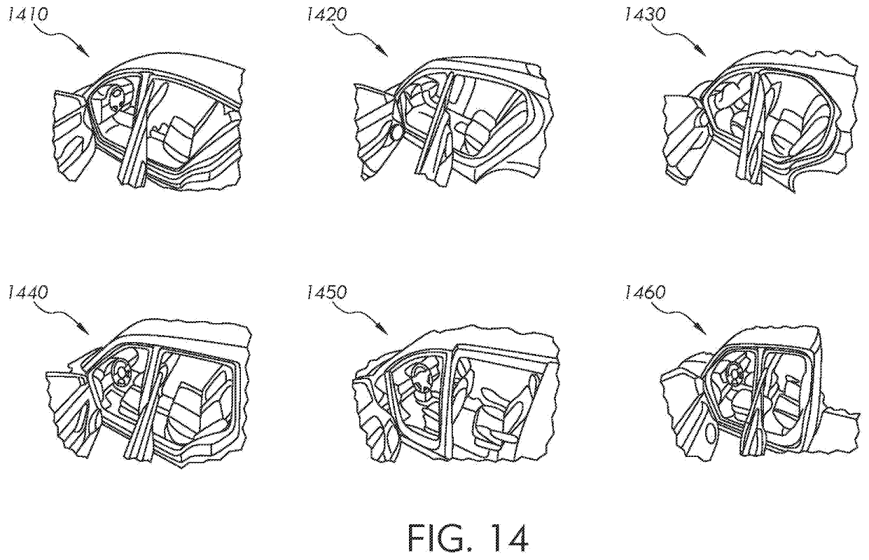

FIG. 15 illustrates a method for seat registration according to an exemplary embodiment. FIG. 15 may incorporate and reference any of the components and functions as explained above with respect to any of the figures described above. At block 1500, the method may include acquiring configuration scans of a door jamb and interior of the vehicle. At block 1510, the method may include loading seat master models. At block 1520, the method may include registering master seat bottom to configuration scans. At block 1530, the method may include registering master seat backrest to configuration scans.

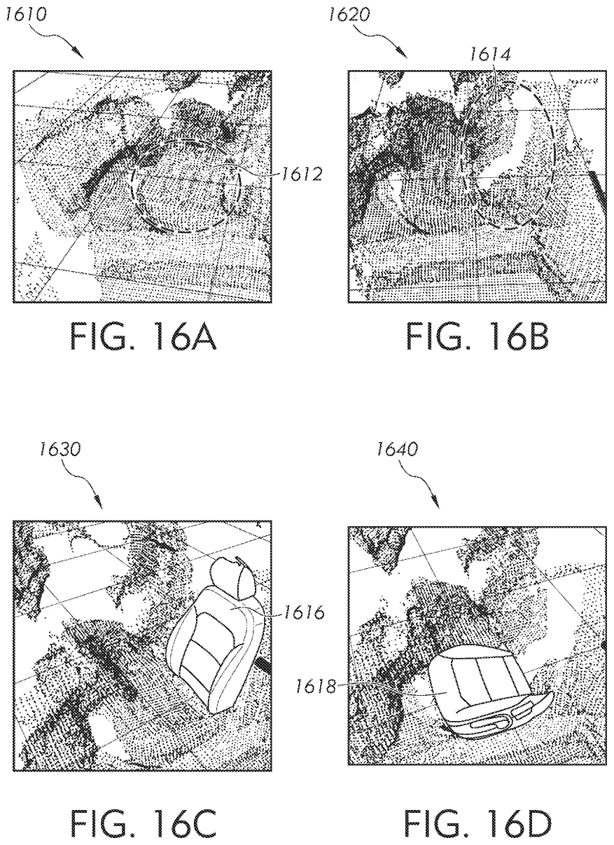

FIGS. 16A-16H illustrates images for pre-registered and registered interior vehicle portions according to an exemplary embodiment. FIGS. 16A-16H may incorporate and reference any of the components and functions as explained above with respect to any of the figures described above. In some examples, FIGS. 16A-16B may be read in conjunction with block 1500 of FIG. 15, FIGS. 16C-16D may be read in conjunction with block 1510 of FIG. 15, FIGS. 16E-16F may be read in conjunction with block 1520 of FIG. 15, and FIGS. 16G-16H may be read in conjunction with block 1530 of FIG. 15. As depicted in image 1610 of FIG. 16A, the points 1612 within the circled region may correspond to a seat bottom of a vehicle. As depicted in image 1620 of FIG. 16B, the points 1614 within the circled region may correspond to a seat backrest of the vehicle. As depicted in 1630 of FIG. 16C, the pre-registered master seat backrest 1616 may be illustrated. As depicted in 1640 of FIG. 16D, the pre-registered master seat bottom 1618 may be illustrated. As depicted in 1650 of FIG. 16E, the pre-registered master seat bottom 1622 may be illustrated. As depicted in 1660 of FIG. 16F, the registered master seat bottom model 1624 may be illustrated. The overlap of points to mesh in the images may indicate similarity. As depicted in 1670 of FIG. 16G, the pre-registered master seat backrest 1626 may be illustrated in green, and the registered model 1628 in gray. As depicted in 1680 of FIG. 16H, the registered master seat backrest model 1632 may be illustrated. The overlap of points to mesh in the images may indicate similarity.

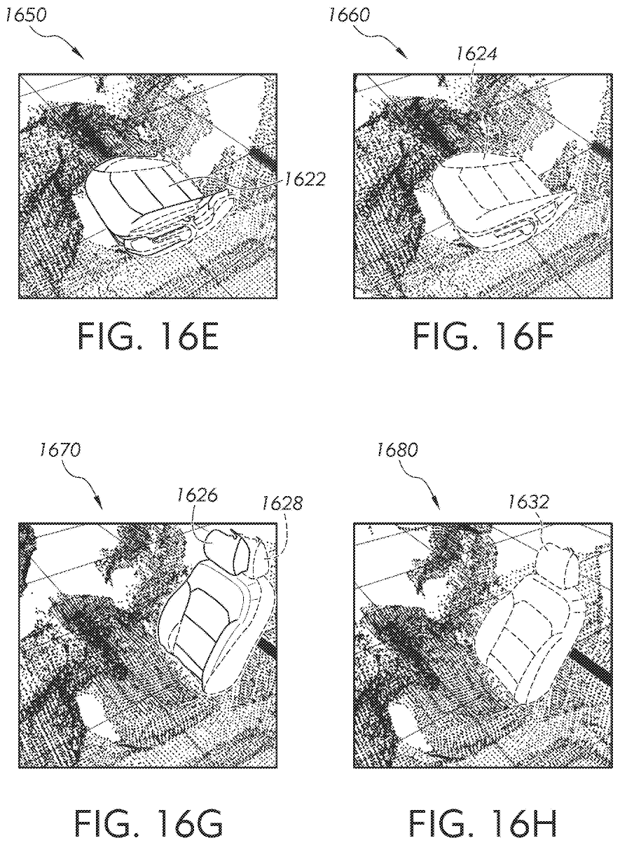

FIG. 17 illustrates an image 1700 of a tooling attachment 1710 according to an exemplary embodiment. FIG. 17 may incorporate and reference any of the components and functions as explained above with respect to any of the figures described above. In some examples, the tooling attachment may be coupled to any of the robotic arms 110. Tooling attachment(s) 1710 can be designed for facilitating cleaning in tight spots. For example, tooling attachments 1710 can be generally longer than conventional attachments, as the wrist of a conventional robot may not fit into tight areas disposed at the floor of the car. However, making the tooling attachment 1710 too long may provide difficulty getting into smaller spaces. Therefore, a sufficient extension length and angle for a component, including but not limited to a vacuum, is needed so that it is able to fit in a space between the seat and the glovebox, for example, in the vehicle interior.

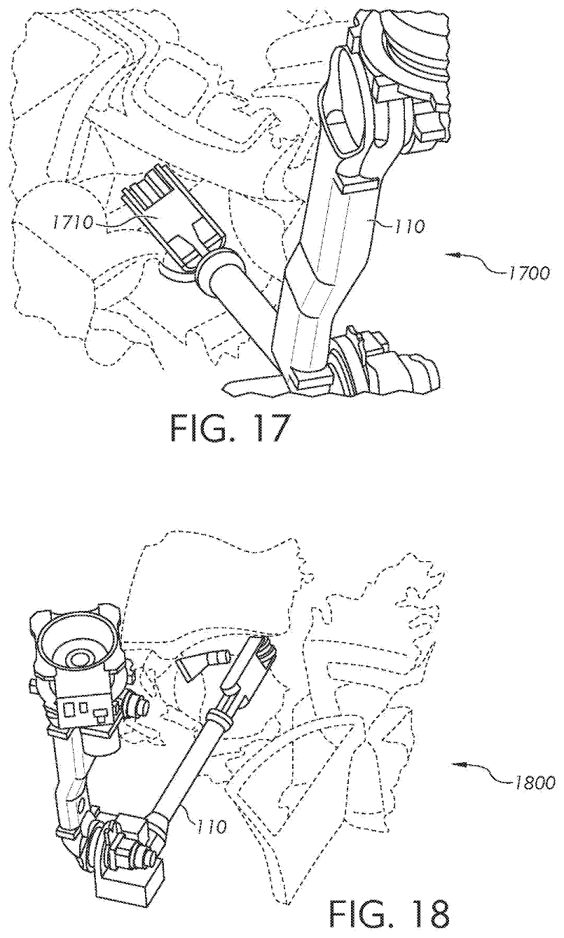

FIG. 18 illustrates an image of a component against a portion of an interior of a vehicle according to an exemplary embodiment. FIG. 18 may incorporate and reference any of the components and functions as explained above with respect to any of the figures described above. For example, this image 1800 illustrates a vacuum against the back of a seat in a scanned car.

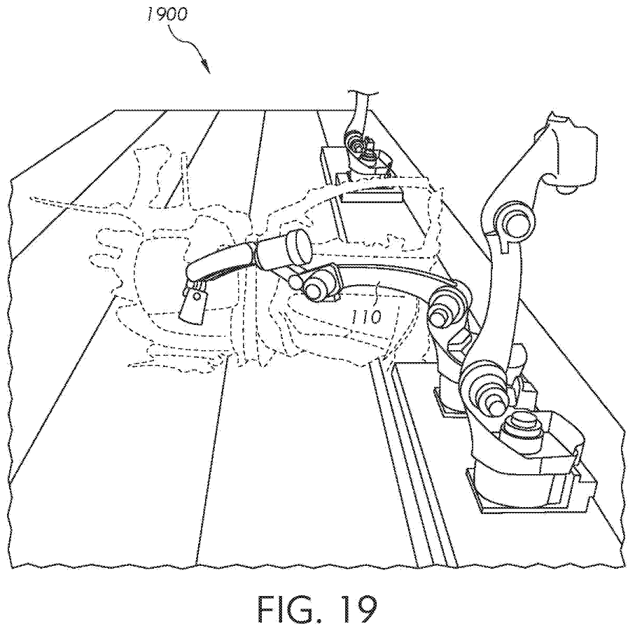

FIG. 19 illustrates an image 1900 of a robot in motion according to an exemplary embodiment. FIG. 19 may incorporate and reference any of the components and functions as explained above with respect to any of the figures described above. For example, this image 1900 illustrates a robotic arm 110 with a scanned model depicting collision in a desired move.

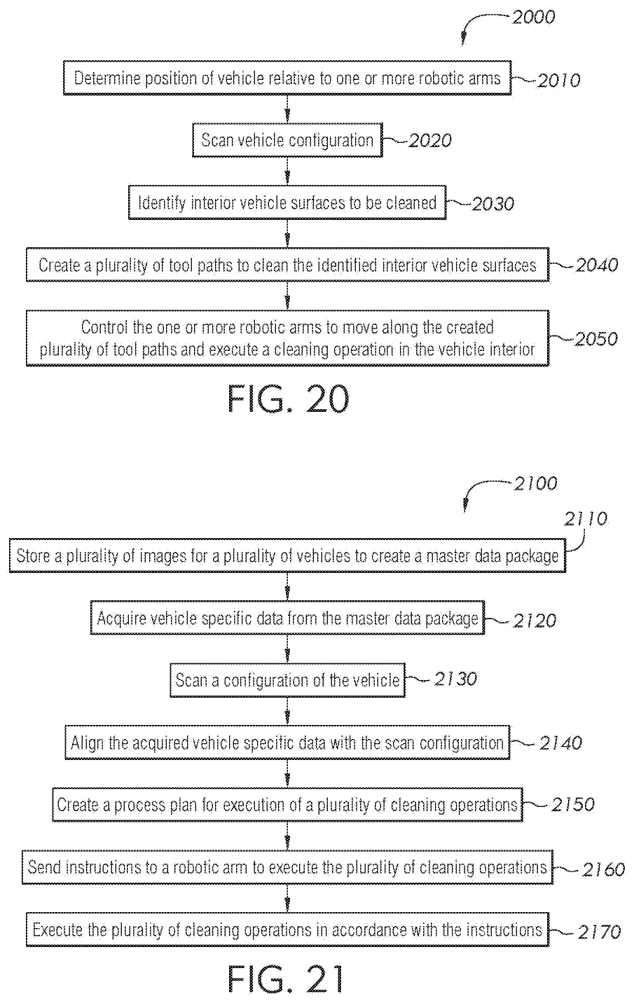

FIG. 20 illustrates a method 2000. The method 2000 may include an automated method for cleaning an interior of a vehicle. The method 2000 and FIG. 20 may reference and include any components and functions described above with respect to any of the figures.

At block 2010, the method 2000 may include determining a position of the vehicle with respect to one or more robotic arms that are positioned exterior to the vehicle. At block 2020, the method 2000 may include scanning a configuration of the vehicle. For example, the method 2000 step may yield a configuration scan. In some examples, scanning the configuration of the vehicle may include capturing a plurality of images of the vehicle. For example, the configuration scan may capture exterior images and interior images of the vehicle.

In some examples, prior to scanning a configuration of the vehicle and block 2020, the method 2000 may also include acquiring information about the vehicle by retrieving master data from a database. The method 2000 may also include aligning data from the configuration scan with the master data. The method 2000 may also include detecting obstacles based on discrepancies between the configuration scan and the aligned master data. In some examples, the plurality of tool paths may be created to avoid the detected obstacles by a predetermined distance.

At block 2030, the method 2000 may include identifying any number of surfaces to be cleaned. In some examples, these surfaces may include interior vehicle surfaces. At block 2040, the method 2000 may include creating a plurality tool paths in MSDP, in which robot trajectories are generated for execution of the MSDP-created tool paths for the one or more robotic arms to clean the identified surfaces. The tool paths may be created as part of the master data package. A tool path(s) may be applied to meshes with appropriate tool information, such as stand-off allowable tool and travel angles. This information may be included in the data scheme that is associated with each segmented region/component. In some examples, creating the plurality of tool paths may include implementing an algorithm that is configured to plan trajectories for the one or more robotic arms using a sampler-based approach. In some examples, the method 2000 may include creating optimized tool paths by running the created plurality of tool paths through a free space motion system and/or cartesian motion planning system.

At block 2050, the method 2000 may include controlling the one or more robotic arms to move along the created tool paths and execute a cleaning operation in the interior of the vehicle. In some examples, the one or more robotic arms may move along the motion planned tool paths to execute a cleaning operation relative to, including but not limited to, the identified surfaces. The tool paths may be clipped/truncated and take into account, for example, steering wheel position, etc. in motion planning or robot trajectory planning. Once the trajectories are planned, they may be sent for execution in association with the cleaning operation.

The method 2000 may further include optimizing a sequencing of a plurality of tasks relative to a time permitted for each task of the plurality of tasks.

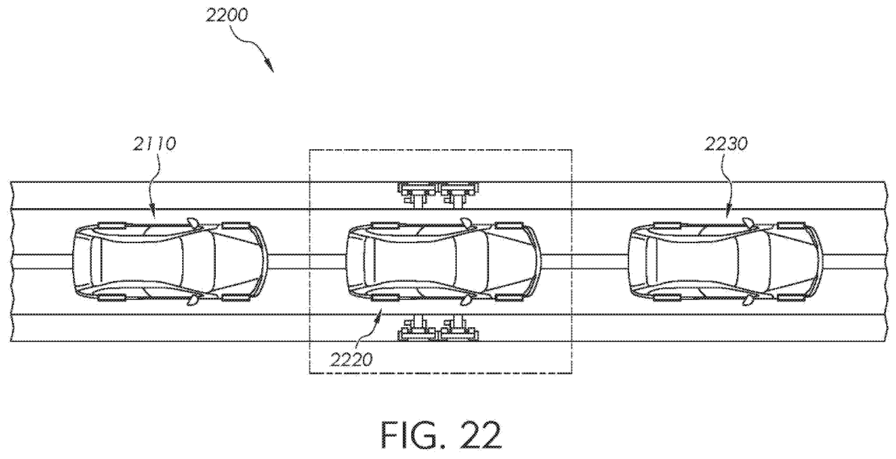

FIG. 21 illustrates a method 2100. The method 2100 may include an automated method for cleaning an interior of a vehicle. The method 2100 and FIG. 21 may reference and include any components and functions described above with respect to any of the figures.

At block 2110, the method 2100 may include storing a plurality of images for a plurality of vehicles in a database to create a master data package. In some examples, and without limitation, the master data package may include a vehicle make and model data, vehicle year data, vehicle class data, and/or any combination thereof.

At block 2120, the method 2100 may include acquiring vehicle specific data from the master data package. At block 2130, the method 2100 may include scanning a configuration of the vehicle. At block 2140, the method 2100 may include aligning the acquired vehicle specific data with the scanned configuration. At block 2150, the method 2100 may include creating a process plan for execution of a cleaning operation. At block 2160, the method 2100 may include sending instructions to a robot to execute a plurality of cleaning operations based on the created process plan. At block 2170, the method 2100 may include executing the cleaning operations according to the instructions.

In some examples, a cycle time, which may be between a start of the scanning the configuration of the vehicle and an end of the execution of the plurality of cleaning operations, may be less than a predetermined time duration. For example, the cycle time may be less than five minutes. In some examples, the method 2100 may also include providing feedback on a quality of the executed plurality of cleaning operations.

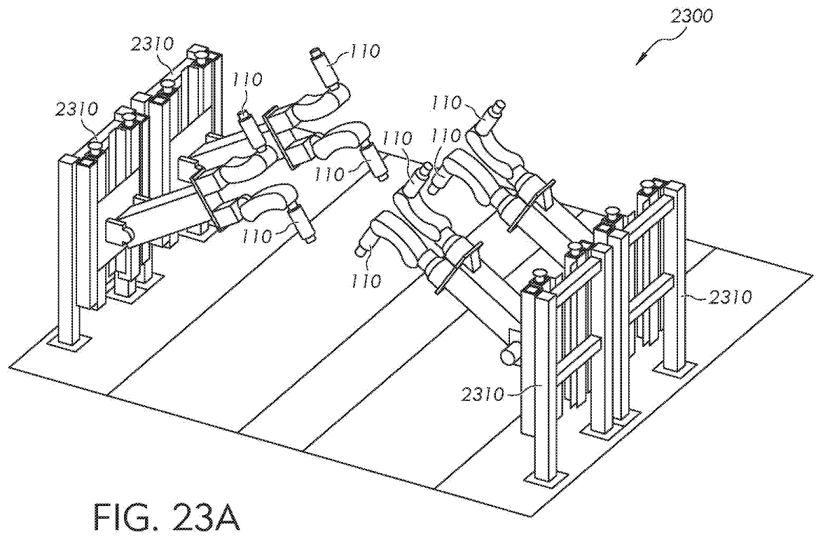

FIG. 22 illustrates a diagram of vehicle zones for cleaning an interior of a vehicle. FIG. 22 may incorporate and reference any of the components and functions as explained above with respect to any of the figures described above. As depicted in diagram 2200, a plurality of zones may be used. For example, the plurality of zones may include Zone 2 denoted 2210, Zone 3 denoted 2220, and Zone 4 denoted 2230. In some examples, Zone 2 2210 and Zone 4 2230 may each comprise human work zones relative to a vehicle, whereas Zone 3 2230 may comprise a robotic work and safe zone. As seen in the image diagram 2200, the system 100 may utilize a conveyor belt 117 system which indexes forward to a fixed position for the robotic arms 110 to conduct its work in the vehicle, in this case a passenger car. The tasks assigned to the robotic arms 110 in Zone 3 2220 may include, but are not limited to, side window cleaning, door panel cleaning, door jamb and frame blowing & drying, and seat and floor vacuuming. To meet overall cycle time requirements, these tasks may be achieved by the robotic arms 110 in under two minutes, a substantial improvement over previous robotic automation designs. Moreover, this cycle time in Zone 3 2220 leaves ample opportunity for the human steps to be completed in Zones 2 and 4 2210, 2230 in a timely, cost-effective manner. Moreover, it enables the entire interior wash operation to be synchronized by system 100 to external wash operations. It is to be appreciated, that the above example workflow is also suitable in a non-conveyor vehicle wash system or in a vehicle wash system that uses conveyors 117 at some zones and not at others.

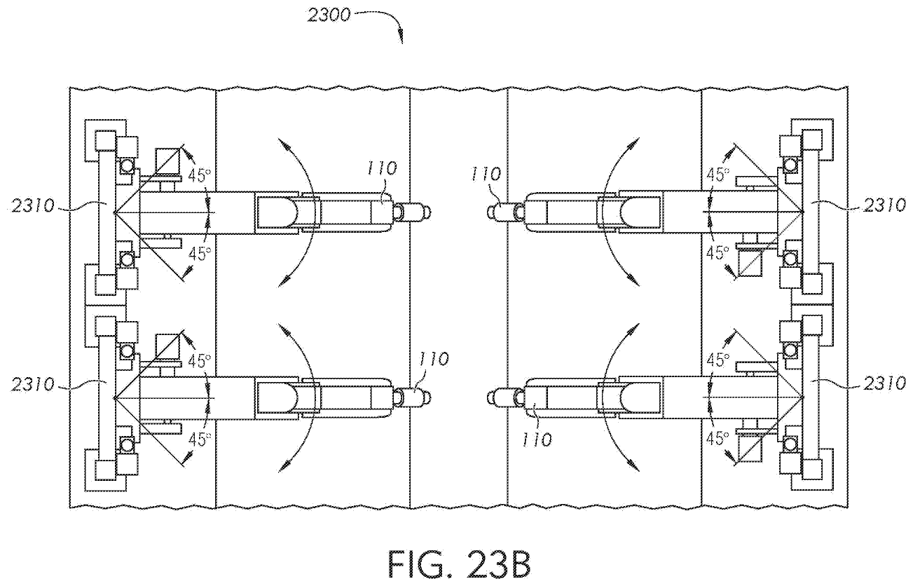

FIG. 23A illustrates a diagram 2300 of robots for cleaning an interior of a vehicle according to an exemplary embodiment. As previously explained above, the system 100 may include any number of robotic arms 110 that are part of one or more interconnected robot systems. Thus, the system 100 employs a networked configuration of robotic arms 110. In some examples, a plurality of robotic arms 110 may be used by the system 100. For example, eight robotic arms 110, each capable of handling more than 5-kilogram payloads may be be attached horizontally to a plurality, including but not limited to four, vertical cantilever structures 2310. Each arm 110 will have up 4 to 7 degrees of freedom, horizontal reach of at least 900 mm, and vertical reach of 1,650 mm. The rate of motion of the slowest arm linkage may be 300+ degrees per second. In some examples, the 6-axis construction and small footprint may allow for easy entry into the vehicle through open doors without need for minimization. In other examples, other configurations can use 4, 5, 6, or 7 robotic arms 110 in this configuration.

Each pair of robotic arms 110 may be configured to employ a sliding cantilever structure 2310 allowing the arm-pair to be positioned horizontal to the floor or perpendicular to it, or controlled to any position in-between. Each cantilever structure 2310 is fastened to and supports a pair of robotic arms 110, and is placed next to the vehicle on either side, with two cantilever structures 2310 per side of the vehicle, next to a front and rear opening for a total of four robotic arm 110 pairs. The cantilever structures 2310 are attached to vertical tracks that allow the robotic arms 110 to rapidly move up and down to reach the optimal height for entering the vehicle and reaching interior surfaces of the vehicle interiors through both the front and back entry doors simultaneously. The cantilever structures 2310 are fastened to a deck on either side of the conveyor 117.

In another example, the system 100 may employ a fifth and/or sixth cantilever structure 2310, each with a robotic arm pair 110, placed toward the rear of the vehicle on a linearly actuated movable platform, so that it can clean the rear portion of the vehicle, trunk and/or hatch, at the same time as the primary interior cleaning operations.

FIG. 23B illustrates a diagram 2300 of a plan view of robots for cleaning an interior of a vehicle according to an exemplary embodiment. As illustrated in FIG. 23B, the cantilever structures 2310 are fastened to a deck on either side of the conveyor 117 (not shown). To simplify entry into the vehicle, the cantilever structures 2310 can be attached to one or two pivot points below and/or above end of a track system, controllably allowing the robotic arm pair 110 to swing freely in an arc up to 90-degrees, 45 degrees to either side of the line perpendicular to the edge of the conveyor 117 (not shown). Additionally, one, or both, decks on either side of the vehicle can be fastened to a linearly actuated movable platform, allowing the entire cantilever structure 2310 to move perpendicular to the conveyor belt 117 by up to 8-feet in both directions.

FIGS. 23A-23B may incorporate and reference any of the components and functions as explained above with respect to any of the figures described above.

The interconnected robot system allows for rapid actuation and end effector placement of the robotic arms 110. The controllers 113, 115 may be configured for high-speed pick and place operations where speed and accuracy are paramount to success of cleaning the interior vehicle by system 100. Current processing speeds allow image-capture-to-robot-arm-movements in as low as 500 milliseconds and control 1,400 actuated work steps per hour up to 1 meter apart.

Each pair of robotic arms 100 are joined in a horizontal position, with the two robotic arms 110 reaching in the same direction, with one lying horizontally atop the other. The robotic arms 110 may work in tandem, each armed with a single- or double-tool end of arm effector. Duties for each robotic arm 110 can be programmed by the interconnected robot system and typically assign one robotic arm 110 to focus on upper portions of the vehicle interior and the other robotic arm 110 the lower portions of the vehicle interior. In some examples, one robotic arm 110 may address window cleaning, followed by cleaning interior door panels, drying the door frame and cleaning the jamb—while the other robotic arm 100 may simultaneously focus on upholstery and floor cleaning. The tooling has been designed so that multiple cleaning effectors are mounted on the robotic arm 110 at once so that the end effectors do not need to be physically removed from the robotic arm 110 to go on to the next task but, instead, can be rotated into and out of place while attached to the robotic arm 110. Coordination and managing collision avoidance between the robotic arms 110, end effectors, and elements of the vehicle may be conducted by the interconnected robot system.

Each interconnected robot system can work in parallel to the others, so that each system and the associated robotic arms 110 are working simultaneously to clean approximately one-quarter of the vehicle interior.

The end effectors of the robotic arms 110 may be configured specifically for the primary robotic vehicle interior cleaning tasks and their throughput requirements. As the robotic arms 100 and end effectors carry out their functions, they may be configured to detect and collect data through a variety of sensors, including: motion, force, vision, torque, and/or other sensors attached to them. The purpose of this data is not only to determine cleaning efficacy but to also refine the 3D maps of the interior for path planning optimization. These data are fed to the path planning process which controls the movements of the robotic arms 110 and tools. In some examples, the tasking of tools may be first handled in the MSDP and tool path creation process, where a tool and its requirements are assigned to specific paths. The tasking and coordination at runtime is handled by a state machine, such as state machine 118 as previously explained above. Over time, the aggregation of data from multiple vehicles will allow the software and its algorithms to determine optimal motion pathways and enable faster responses to non-standard items within the vehicle (such as baby seats, aftermarket items, etc.), further reducing cycle times and speeding the process of cleaning vehicle interiors.

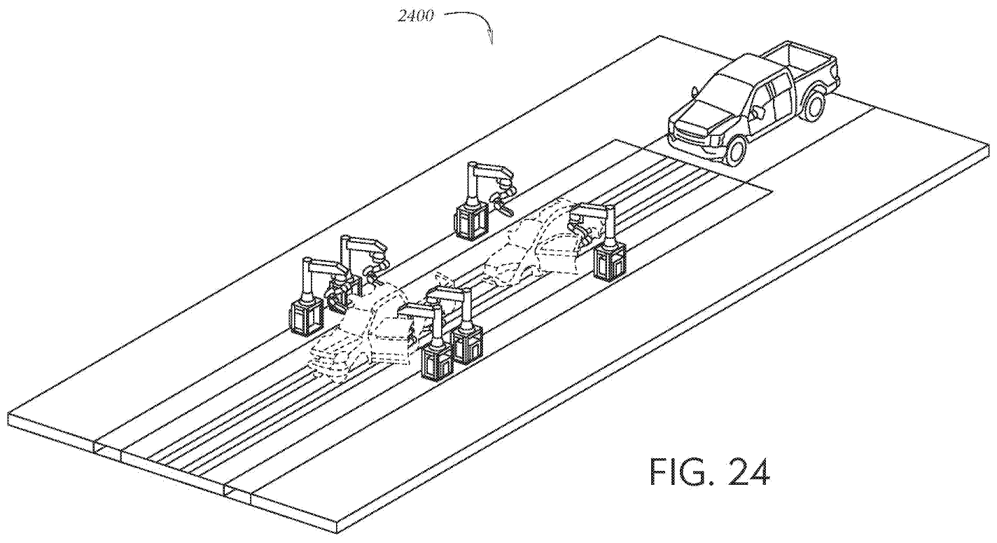

FIG. 24 illustrates a schematic 2400 of a vehicle transiting through stages of interior cleaning according to an exemplary embodiment. FIG. 24 may incorporate and reference any of the components and functions as explained above with respect to any of the figures described above. While a pickup truck is depicted, it is understood that any type of vehicle may be applicable, and as such is not limited to this type of vehicle. A plurality of robotic arms, such as arms 110, may be included, as previously explained. In addition, the schematic 2400 is illustrated to depict the entry of the vehicle relative to, for example, the stages B and C of the system 100.

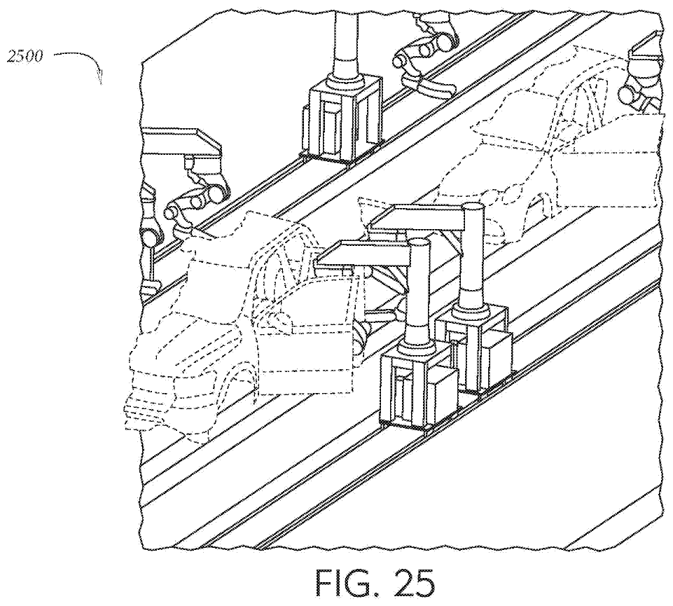

FIG. 25 illustrates a schematic 2500 of a vehicle transiting through stages of interior cleaning according to another exemplary embodiment. FIG. 25 may incorporate and reference any of the components and functions as explained above with respect to any of the figures described above. A plurality of robotic arms, such as arms 110, may be included, as previously explained. In addition, the schematic 2500 is illustrated to depict the location of the vehicle relative to the stages B and C, and in particular a close view of the arms in stage C and partially stage B of the system 100.

By way of example, the workflow of the systems and methods described herein has been designed, configured, and optimized to minimize cost by retaining human activities least cost-effective for automation—such as placement of vehicle on the conveyor, opening doors, removing and replacing removable items out of and into the vehicle, handling one-off items, and conducting final quality control. In addition, human workers may be responsible for cleaning rear- and forward-facing window glass interior surfaces, cleaning the trunk area, and removing, cleaning, and replacing floor mats. In this regard, some zones include human workers present on the conveyor system whereas other zones include robot system and are designed to prevent human presence to reduce the risk of injury. The systems and methods described herein focus the robotic activities on those prone to poor quality, cumbersome to complete, and/or those posing the most risk to worker comfort, safety, and vehicle damage.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for cleaning an interior of a vehicle comprising:
a robotic arm positioned outside of the vehicle, the robotic arm including an end effector configured as a cleaning implement for cleaning a surface in the interior of the vehicle;
a first camera configured to determine a position of the vehicle with respect to a reference point;
a second camera configured to scan the interior of the vehicle; and
a first controller configured to create and/or modify a tool path to execute a cleaning operation, based on the scan, and to send instructions to the robotic arm to execute the cleaning operation in accordance with the created and/or modified tool path.

2. The system of claim 1, further comprising a communication system coupled to the controller.

3. The system of claim 2, wherein the communication system includes a quality assurance feedback loop.

4. The system of claim 1, further comprising a second controller configured to receive data from one or more sensors to mitigate collision.

5. The system of claim 1, wherein the second camera is configured to detect at least one of a seat position, a steering wheel position, and an object present in the vehicle.

6. The system of claim 1, wherein the second camera is positioned outside of the vehicle.

7. The system of claim 1, wherein the second camera is coupled to the robotic arm.

8. The system of claim 1, wherein at least one of the first camera and the second camera comprises a 3D camera.

9. The system of claim 1, further comprising a database of a plurality of stored vehicle configurations.

10. The system of claim 1, wherein at least one of the robotic arm and the end effector includes a sensor to detect objects present in the vehicle.

11. The system of claim 1, wherein the first camera is located at a position above a roof of the vehicle.

12. The system of claim 1, further comprising a linear rail located above the vehicle, the robot arm movable along the linear rail.

13. The system of claim 12, further comprising a conveyor upon which the vehicle is carried, and
wherein the robot is configured to move along the linear rail in coordination with a motion of the conveyor.

14. The system of claim 1, further comprising a state machine configured to manage timing and coordination of a plurality of cleaning implements associated with a plurality of robotic arms.

15. An automated method for cleaning an interior of a vehicle comprising:
determining a position of the vehicle with respect to one or more robotic arms positioned exterior to the vehicle;
scanning a configuration of the vehicle to yield a configuration scan;
identifying surfaces to be cleaned;
creating and/or modifying a plurality of tool paths for the one or more robotic arms to clean the identified surfaces; and
controlling the one or more robotic arms to move along the created and/or modified plurality of tool paths and execute a cleaning operation in the interior of the vehicle.

16. The method of claim 15, further comprising, prior to scanning the configuration of the vehicle, acquiring information about the vehicle by retrieving master data from a database.

17. The method of claim 16, further comprising aligning data from the configuration scan with the master data.

18. The method of claim 16, further comprising detecting obstacles based on discrepancies between the configuration scan and the aligned master data.

19. The method of claim 18, wherein the plurality of tool paths are created and/or modified to avoid the detected obstacles by a predetermined distance.

20. The method of claim 16, wherein scanning the configuration of the vehicle includes scanning a doorjamb, and wherein the scanned doorjamb configuration is aligned with corresponding doorjamb data stored in the master data.

21. The method of claim 15, wherein scanning the configuration of the vehicle includes capturing a plurality of exterior images and interior images of the vehicle.

22. The method of claim 15, further comprising creating optimized tool paths by running the created tool paths through at least one of a free space motion system and a cartesian motion planning system.

23. The method of claim 15, wherein creating the plurality of tool paths includes implementing an algorithm to plan trajectories for the robot using a sampler-based approach.

24. The method of claim 15, further comprising optimizing a sequencing of tasks relative to a time permitted for each task.

25. An automated method for cleaning an interior of a vehicle comprising:
storing a plurality of images for a plurality of vehicles in a database to create a master data package;
acquiring vehicle specific data from the master data package;
scanning a configuration of the vehicle;
aligning the acquired vehicle specific data with the scanned configuration;
creating a process plan for execution of a plurality of cleaning operations;
sending instructions to a robot to execute the plurality of cleaning operations based on the process plan; and
executing the plurality of cleaning operations in accordance with the instructions.

26. The method of claim 25, wherein the master data package includes at least one of vehicle make and model data, vehicle year data, and vehicle class data.

27. The method of claim 25, wherein a cycle time between a start of the scanning the configuration of the vehicle and an end of the execution of cleaning operations is less than five minutes.

28. The method of claim 25, further comprising providing feedback on a quality of the executed plurality of cleaning operations.
